(19) United States
(12) Patent Application Publication
(10) Pub. No.: US 2026/0288148 A1
(43) Pub. Date: Sep. 24, 2026

(54) Recognition-Based Autonomous Navigation Systems, Methods, and Non-Transitory Computer-Readable Media

(71) Applicant: Jonathan Washburn, Austin, TX (US)

(72) Inventor: Jonathan Washburn, Austin, TX (US)

(21) Appl. No.: 19/570,526

(22) Filed: Mar. 18, 2026

Related U.S. Application Data
(60) Provisional application No. 63/774,220, filed on Mar. 19, 2025.

(51) Int. Cl. G05D 1/617; G05D 1/644; G05D 111/10; G05D 111/30; G05D 111/50; G05D 111/67

(52) U.S. Cl. CPC G05D 1/617; G05D 1/644; G05D 2111/17; G05D 2111/30; G05D 2111/52; G05D 2111/67

(57) ABSTRACT

Recognition-based autonomous navigation systems, methods, and non-transitory computer-readable media are disclosed. Sensor data for an environment of an autonomous or semi-autonomous platform is received, and a recognition metric is derived from sensed, computed, inferred, or estimated values. The recognition metric is normalized and mapped to a bounded recognition factor. The bounded recognition factor is applied to weighting of sensor-derived inputs to produce a fused perceptual output, scaling of neural inference or detection quantities to produce a detected-object output, adjustment of path-planning costs to produce a path output, and mapping of risk-related inputs to produce a priority for tasks, control decisions, or resource allocation. The outputs are used to generate control commands for the platform.

### CROSS-REFERENCE TO RELATED APPLICATIONS

This application claims the benefit of U.S. Provisional Patent Application No. 63/774,220, filed on Mar. 19, 2025, the entire disclosure of which is hereby incorporated by reference herein in its entirety.

### BACKGROUND OF THE INVENTION

The present disclosure relates generally to autonomous navigation and robotic control systems and, more particularly, to systems and methods for improving perception, inference, path planning, and decision execution in autonomous or semi-autonomous platforms operating in dynamic environments.

Autonomous systems are often required to perceive, interpret, and respond to rapidly changing surroundings while maintaining safe and efficient operation. In practical deployments, such systems may rely on multiple sensors, including cameras, radar, LiDAR, ultrasonic sensors, inertial sensors, global positioning components, or other sensing modalities, each of which may experience changing reliability depending on environmental conditions, obstruction, noise, lighting, weather, terrain, speed, latency, interference, or partial failure. As a result, the quality of information made available to downstream autonomy functions can vary substantially over time.

Conventional autonomous navigation architectures frequently process sensed information, detected objects, candidate trajectories, and task priorities using fixed or weakly adaptive weighting approaches. In many cases, such approaches do not adequately account for changing confidence, quality, or reliability within the incoming data or within derived intermediate representations. This can lead to over-reliance on degraded sensor channels, propagation of weak or unstable neural activations, insufficient distinction between more reliable and less reliable candidate paths, or inefficient use of computational resources when urgent decisions must be made.

In perception pipelines, conventional fusion techniques may combine sensor outputs without sufficiently modifying sensor contribution as a function of real-time reliability or recognition quality. In object detection and related neural inference tasks, conventional processing may permit low-value or weakly informative activations to propagate in ways that increase noise sensitivity, false detections, unstable classification behavior, or unnecessary computational burden. In path planning, conventional planners may fail to directly incorporate bounded confidence measures associated with traversability, free-space verification, map consistency, or obstacle certainty into the cost structures used to rank candidate routes. In decision scheduling and task management, conventional systems may allocate processing attention, communication priority, or execution timing without a sufficiently unified mechanism for translating real-time operational risk into execution priority.

These limitations become more significant in real-world deployment settings, including road vehicles, commercial transport systems, unmanned aerial systems, marine platforms, agricultural robotics, warehouse automation systems, and other autonomous machines, where sensor conditions, scene complexity, and safety demands may change from moment to moment.

Accordingly, a need exists for improved autonomous navigation systems and methods that can generate and apply a bounded recognition-based factor to adaptively influence multiple navigation functions, including sensor fusion, neural inference, path evaluation, and decision prioritization, in a coherent and computationally efficient manner.

### BRIEF DESCRIPTION OF THE DRAWINGS

FIG. 1 illustrates an example recognition-based autonomous navigation system including a recognition coverage engine, a sensor fusion subsystem, an object detection subsystem, a path planning subsystem, and a decision engine configured to support autonomous or semi-autonomous navigation.

FIG. 2 illustrates an example vehicle hardware and sensor architecture that may be used to implement the recognition-based autonomous navigation system, including representative sensing components, computing components, control components, and actuator components.

FIG. 3 illustrates an example recognition coverage engine and normalization architecture configured to receive one or more recognition-related inputs, normalize one or more recognition metrics, and generate a bounded recognition factor for use by one or more navigation-related subsystems.

FIG. 4 illustrates an example recognition-based sensor fusion subsystem configured to evaluate sensor reliability or related recognition information and to generate a fused perceptual output based on recognition-adjusted weighting of sensor data.

FIG. 5 illustrates an example recognition-optimized object detection subsystem configured to apply a recognition-based factor to one or more neural inference values, activation values, feature values, or detection-related outputs to improve perception processing.

FIG. 6 illustrates an example recognition-based path planning subsystem configured to modify path cost, node cost, edge cost, or related traversal values based on recognition-derived information associated with traversability, clearance, confidence, or environmental certainty.

FIG. 7 illustrates an example recognition-driven decision engine configured to generate recognition-based decision priorities from one or more risk-related inputs and to allocate execution priority, processing attention, or system resources accordingly.

FIG. 8 illustrates an example end-to-end recognition-based navigation control loop in which recognition-adjusted sensing, perception, planning, and decision operations are used to generate control outputs for an autonomous or semi-autonomous platform.

### DETAILED DESCRIPTION OF THE INVENTION

The following detailed description sets forth exemplary embodiments of the disclosed subject matter and is intended to describe the invention in sufficient detail to enable a person of ordinary skill in the art to make and use the invention. The disclosed subject matter is not limited to the specific embodiments described herein, and it will be understood that various modifications, substitutions, rearrangements, additions, and combinations may be made without departing from the spirit and scope of the invention. Unless expressly stated otherwise, references to a component, module, engine, subsystem, processor, or interface include one or more such components, modules, engines, subsystems, processors, or interfaces, whether implemented in hardware, software, firmware, or a combination thereof. Likewise, references to communication, coupling, or connection between elements may include direct coupling, indirect coupling, communicative coupling, electrical coupling, logical coupling, data coupling, mechanical coupling, or combinations thereof.

In various embodiments, the disclosed subject matter relates to recognition-based autonomous navigation systems, methods, and non-transitory computer-readable media in which a bounded recognition factor is computed from one or more recognition-related inputs and is then applied to one or more navigation functions of an autonomous or semi-autonomous platform. The disclosed subject matter may be implemented in passenger vehicles, commercial trucks, unmanned aerial vehicles, marine vessels, agricultural machines, warehouse automation systems, delivery robots, planetary rovers, or other robotic or mobile systems that perform sensing, perception, planning, and control operations in changing environments. In preferred implementations, a recognition factor is generated from a normalized recognition metric and is used to influence sensor fusion, object detection, path planning, decision prioritization, or combinations thereof so that operation of the platform can adapt to changing sensor quality, changing environmental conditions, changing certainty levels, and changing operational risk.

In some embodiments, a recognition metric may correspond to or be derived from confidence, reliability, consistency, salience, traversability, certainty, urgency, hazard, risk, or another quantity associated with the quality or significance of data, states, paths, objects, or decisions used by the system. A recognition metric may be obtained from raw sensor values, sensor-derived values, learned outputs, model-based outputs, fused values, map values, estimated values, or any combination thereof. In some embodiments, one or more recognition metrics may be normalized to produce a dimensionless or otherwise scaled value suitable for processing by a recognition mapping function. The recognition mapping function may generate a bounded recognition factor that increases as the normalized recognition metric increases and that remains within a bounded range to promote stable use across multiple subsystems. In preferred embodiments, the recognition factor may be computed according to the following expression:

F_cov(r; X)=r/(r+X)

where r is a nonnegative normalized recognition metric and X is a positive constant. In some preferred embodiments, X may be selected as phi/pi. However, the disclosed subject matter is not limited to that value, and other constants, scaling values, parameterizations, approximations, or bounded monotonic transforms may be used in other embodiments. In some implementations, the normalized recognition metric may be represented as:

r=m/m_scale

where m is a recognition-related input and m_scale is a selected scale, reference value, calibration value, or normalization factor. In some other implementations, the normalized recognition metric may be derived from a probability-related input according to:

r=p/(1−p+epsilon)

where p is a probability-like value and epsilon is a small positive constant used for numerical stability. Other normalization formulations may also be used.

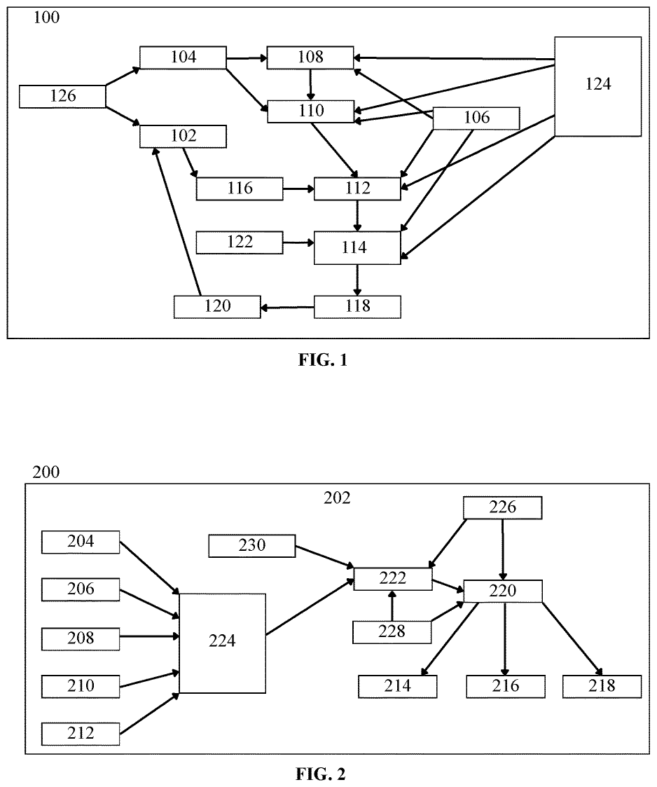

Referring now to FIG. 1, an example recognition-based autonomous navigation system 100 is illustrated. In the illustrated embodiment, the autonomous navigation system 100 may include a vehicle platform 102, a sensor suite 104, a recognition coverage engine 106, a recognition-based sensor fusion subsystem 108, a recognition-optimized object detection subsystem 110, a recognition-based path planning subsystem 112, a recognition-driven decision engine 114, a localization and mapping subsystem 116, a control interface 118, an actuator subsystem 120, a communication interface 122, a computing subsystem 124, and an external environment 126.

Although these components are shown as distinct functional blocks for ease of illustration, it will be understood that any two or more components may be combined, subdivided, distributed, virtualized, replicated, or otherwise arranged differently in other embodiments.

The vehicle platform 102 may correspond to any autonomous or semi-autonomous machine configured to sense an environment, determine one or more actions, and generate one or more control outputs. In some embodiments, the vehicle platform 102 may be an on-road passenger vehicle. In other embodiments, the vehicle platform 102 may be a truck, unmanned aerial vehicle, marine vessel, agricultural platform, warehouse robot, delivery robot, rover, or another mobile robotic platform. The external environment 126 may include roads, lanes, intersections, terrain, obstacles, pedestrians, vehicles, structures, weather conditions, illumination conditions, dynamic objects, static objects, or other environmental features relevant to navigation.

The sensor suite 104 may be configured to obtain information associated with the external environment 126 and with the state of the vehicle platform 102. In some embodiments, the sensor suite 104 may include one or more cameras, one or more radar sensors, one or more LiDAR sensors, one or more ultrasonic sensors, one or more inertial sensors, one or more positioning sensors, one or more odometry sources, or other sensing devices. The sensor suite 104 may provide raw sensor data, preprocessed data, feature data, object proposals, state estimates, environmental measurements, or other information to the recognition-based sensor fusion subsystem 108, the recognition-optimized object detection subsystem 110, the localization and mapping subsystem 116, or other components of the system 100.

The recognition coverage engine 106 may receive one or more recognition-related inputs and may generate one or more bounded recognition factors for use by one or more other subsystems.

In some embodiments, the recognition coverage engine 106 may receive one or more normalized recognition metrics derived from sensor quality values, feature magnitudes, object confidence values, traversability values, map certainty values, risk values, urgency values, or combinations thereof. The recognition coverage engine 106 may generate a shared recognition factor for use across multiple subsystems, or may generate separate recognition factors for different subsystems. In some embodiments, the recognition coverage engine 106 may implement an exact closed-form recognition mapping. In other embodiments, the recognition coverage engine 106 may implement a lookup table, an approximation routine, a piecewise function, a fixed-point approximation, or another bounded mapping implementation.

The recognition-based sensor fusion subsystem 108 may be configured to receive multiple sensor inputs or sensor-derived inputs and to generate a fused perceptual representation in which the contribution of one or more inputs is modified according to one or more recognition factors. In some embodiments, the recognition-based sensor fusion subsystem 108 may determine one or more reliability-related or confidence-related measures associated with individual sensor streams or sensor-derived representations, may convert such measures into one or more recognition metrics, and may use one or more resulting recognition factors to weight, gate, scale, suppress, enhance, or otherwise modify sensor contributions before, during, or after a fusion process. In this manner, the system may reduce over-reliance on degraded or low-confidence inputs and may increase reliance on stronger or more reliable inputs.

The recognition-optimized object detection subsystem 110 may be configured to receive sensor data, fused perceptual data, intermediate network features, or other input representations and to generate object detections, classifications, localization outputs, semantic outputs, tracking-related outputs, or combinations thereof. In some embodiments, the recognition-optimized object detection subsystem 110 may apply one or more recognition factors to one or more neural activations, feature maps, logits, confidence values, channel values, attention values, objectness values, detection thresholds, or post-processing values. In some implementations, weak, unstable, noisy, or low-information values may be relatively suppressed, while stronger or more reliable values may be preserved or emphasized. This can improve detection stability and downstream decision quality in changing conditions.

The recognition-based path planning subsystem 112 may be configured to determine one or more candidate paths, trajectories, control sequences, or navigational actions for the vehicle platform 102. In some embodiments, the recognition-based path planning subsystem 112 may operate on a graph, lattice, grid, map, free-space representation, occupancy representation, waypoint set, spline representation, sampled-trajectory representation, or other path-planning structure. One or more recognition factors may be used to modify node cost, edge cost, trajectory cost, traversal cost, safety margin, uncertainty penalty, or another quantity associated with path selection. In some implementations, candidate paths associated with greater certainty, greater verified clearance, or greater traversability confidence may be assigned more favorable effective costs than candidate paths associated with lower certainty or greater uncertainty.

The recognition-driven decision engine 114 may be configured to prioritize, schedule, sequence, select, or allocate actions, tasks, resources, or control decisions based on one or more recognition-derived priority values. In some embodiments, the recognition-driven decision engine 114 may compute one or more risk-related metrics from quantities such as inverse time-to-collision, object confidence, relative velocity, predicted hazard, path conflict, rule-criticality, mission priority, actuator state, or combinations thereof. One or more recognition factors may then be generated from such risk-related metrics and used to determine processing order, execution priority, communication priority, compute allocation, memory allocation, control-loop timing, or actuator update priority. In this way, more urgent or safety-relevant decisions may be elevated relative to lower-priority tasks.

The localization and mapping subsystem 116 may be configured to estimate a pose, position, orientation, velocity, map state, free-space state, landmark state, or environmental model associated with the vehicle platform 102 and the external environment 126. In some embodiments, the localization and mapping subsystem 116 may provide position estimates, map values, map confidence values, free-space confidence values, localization confidence values, or related information to the recognition-based path planning subsystem 112, the recognition-driven decision engine 114, or other system components. The localization and mapping subsystem 116 may be implemented using map matching, simultaneous localization and mapping, inertial estimation, GNSS estimation, visual odometry, LiDAR odometry, radar odometry, cooperative localization, or combinations thereof.

The control interface 118 may receive one or more selected paths, control commands, priorities, decisions, or action outputs from the recognition-based path planning subsystem 112, the recognition-driven decision engine 114, or both, and may generate command signals suitable for controlling the actuator subsystem 120. The actuator subsystem 120 may include steering components, braking components, propulsion components, control surfaces, thrust control elements, robotic joint drives, or other actuation elements depending on the platform type. The communication interface 122 may support internal communications, external communications, vehicle-to-vehicle communications, vehicle-to-infrastructure communications, wireless data exchanges, remote supervisory communications, fleet coordination, cloud communications, or combinations thereof. The computing subsystem 124 may include one or more processors, accelerators, memory devices, storage devices, interface devices, or software components configured to implement the functionality described herein.

In operation, the autonomous navigation system 100 may receive sensor information from the sensor suite 104, may derive one or more recognition metrics from one or more sensed, computed, or inferred values, may compute one or more recognition factors using the recognition coverage engine 106, and may apply such recognition factors within one or more of the recognition-based sensor fusion subsystem 108, the recognition-optimized object detection subsystem 110, the recognition-based path planning subsystem 112, and the recognition-driven decision engine 114. Resulting outputs may be used by the control interface 118 to generate control actions for the actuator subsystem 120 so that the vehicle platform 102 can navigate the external environment 126 in a manner responsive to changing certainty, changing risk, and changing operational conditions.

In some embodiments, the recognition factor may be used in a common or unified manner across multiple subsystems so that sensing, perception, planning, and decision operations share a consistent bounded weighting logic. In other embodiments, different recognition metrics, different recognition maps, different constants, or different scaling values may be used in different subsystems. For example, a first recognition factor may be generated from a sensor-reliability metric for use in sensor fusion, a second recognition factor may be generated from an activation-related metric for use in object detection, a third recognition factor may be generated from a traversability-related metric for use in path planning, and a fourth recognition factor may be generated from a risk-related metric for use in decision prioritization. The disclosed subject matter is intended to encompass each such implementation.

In some embodiments, one or more portions of the system may operate continuously, periodically, event-driven, asynchronously, or according to a hybrid timing arrangement. Sensor acquisition, recognition-factor generation, perception updates, path planning updates, risk assessment, and control command generation may be repeated at fixed intervals, variable intervals, or in response to triggers such as new sensor arrivals, obstacle detection, localization changes, operator instructions, mission updates, hazard detections, or system-state changes. The disclosed subject matter therefore supports a wide range of real-time and near-real-time navigation architectures.

Referring now to FIG. 2, an example vehicle hardware and sensor architecture 200 is illustrated for implementing the recognition-based autonomous navigation system described herein. In the illustrated embodiment, the vehicle hardware architecture 200 may include a chassis or platform body 202, a LiDAR subsystem 204, a radar subsystem 206, a camera subsystem 208, an ultrasonic subsystem 210, an inertial and positioning subsystem 212, a steering actuator 214, a braking actuator 216, a propulsion actuator 218, a vehicle bus 220, a control processor 222, a sensor interface processor 224, a power subsystem 226, a safety override interface 228, and a wireless transceiver 230. Although FIG. 2 illustrates one example arrangement, it will be understood that a given implementation may omit one or more illustrated elements, may add additional elements, or may arrange such elements differently depending on platform type, cost, safety requirements, operating environment, or regulatory constraints.

The chassis or platform body 202 may correspond to the structural and mechanical platform on which sensing, computing, control, and actuation components are mounted or integrated. In an on-road vehicle embodiment, the chassis or platform body 202 may include a passenger vehicle body, truck body, van body, or specialty vehicle frame. In other embodiments, the chassis or platform body 202 may correspond to an unmanned aerial vehicle frame, a marine vessel hull, an agricultural machine body, a warehouse robot frame, a delivery robot housing, or a rover structure. The chassis or platform body 202 may support sensor mounting points, compute enclosures, wiring harnesses, bus connections, power distribution paths, cooling structures, and actuator interfaces used by the remainder of the vehicle hardware architecture 200.

The LiDAR subsystem 204 may include one or more light detection and ranging sensors configured to generate range information, point-cloud information, reflectivity information, depth information, contour information, or other spatial information associated with objects or environmental features surrounding the platform. In some embodiments, the LiDAR subsystem 204 may provide near-field and far-field depth measurements suitable for obstacle detection, free-space estimation, localization support, mapping support, or path planning support. In some implementations, the LiDAR subsystem 204 may include one or more scanning LiDAR units, solid-state LiDAR units, flash LiDAR units, or other depth-sensing devices. Data generated by the LiDAR subsystem 204 may be provided to the sensor interface processor 224, the control processor 222, or one or more perception-related modules for preprocessing, synchronization, filtering, feature extraction, or recognition-based weighting as described elsewhere herein.

The radar subsystem 206 may include one or more radar sensors configured to detect range, relative velocity, Doppler information, object motion, object presence, or other environmental information. In some embodiments, the radar subsystem 206 may be particularly useful under lighting conditions, weather conditions, or partial-obscuration conditions in which optical sensing performance may be reduced. The radar subsystem 206 may include short-range radar, mid-range radar, long-range radar, imaging radar, or other radar modalities. Data from the radar subsystem 206 may be used independently or together with data from the LiDAR subsystem 204, the camera subsystem 208, the ultrasonic subsystem 210, or the inertial and positioning subsystem 212 to support recognition-based sensor fusion, obstacle estimation, object tracking, environmental modeling, and navigation decision-making.

The camera subsystem 208 may include one or more visible-light cameras, stereo cameras, infrared cameras, thermal cameras, event cameras, depth cameras, or other image-forming devices. In some embodiments, the camera subsystem 208 may provide image frames, video streams, feature maps, segmentation inputs, lane-detection inputs, object-detection inputs, texture information, semantic scene information, traffic-control information, signage information, or other visual information relevant to autonomous navigation. The camera subsystem 208 may include forward-facing cameras, rear-facing cameras, side-facing cameras, surround-view cameras, upward-facing cameras, downward-facing cameras, or other placements depending on platform geometry and operating requirements. Visual data generated by the camera subsystem 208 may be supplied to the sensor interface processor 224, the control processor 222, or one or more recognition-based perception modules for inference, fusion, and downstream decision processing.

The ultrasonic subsystem 210 may include one or more near-field sensors configured to detect nearby objects, surfaces, boundaries, or clearance conditions. In some embodiments, the ultrasonic subsystem 210 may support parking maneuvers, low-speed navigation, docking operations, obstacle avoidance, proximity monitoring, or close-range robotic interactions. Although ultrasonic sensing is specifically illustrated, other near-field sensing technologies may be used in additional or alternative embodiments, including short-range optical sensing, capacitive sensing, tactile sensing, structured light sensing, or other local-detection approaches.

The inertial and positioning subsystem 212 may include one or more inertial measurement units, accelerometers, gyroscopes, magnetometers, wheel-speed sensors, wheel encoders, odometry sources, GNSS receivers, dead-reckoning components, visual odometry sources, LiDAR odometry sources, radar odometry sources, or combinations thereof. In some embodiments, the inertial and positioning subsystem 212 may provide vehicle-state information including position, orientation, heading, angular rate, linear acceleration, velocity, displacement, or pose estimates. Such information may be used to support localization, control stabilization, trajectory following, motion compensation, sensor registration, and synchronization of multi-sensor information across time.

The steering actuator 214 may be configured to generate steering commands or directional-control outputs for the platform. In an on-road embodiment, the steering actuator 214 may control one or more steering mechanisms associated with front wheels, rear wheels, or all-wheel steering systems. In another embodiment, the steering actuator 214 may correspond to a rudder-control mechanism, fin-control mechanism, thrust-vectoring mechanism, rotor-control mechanism, or robotic joint-control element depending on platform type. The braking actuator 216 may be configured to generate deceleration, stopping, holding, or braking-related actions.

The propulsion actuator 218 may be configured to generate forward motion, reverse motion, thrust, torque, motor drive, engine control, propeller control, wheel drive, track drive, rotor thrust, or other propulsion-related outputs. Together, the steering actuator 214, braking actuator 216, and propulsion actuator 218 may form part of the controlled actuation set used to execute navigation decisions generated by the disclosed system.

The vehicle bus 220 may provide a communication pathway between sensing components, computing components, control components, and actuation components. In some embodiments, the vehicle bus 220 may include one or more controller area network buses, Ethernet buses, time-sensitive networking links, serial buses, high-speed sensor links, avionics buses, marine control buses, industrial communication buses, or combinations thereof. The vehicle bus 220 may carry raw sensor data, processed sensor data, timing signals, diagnostic information, control commands, safety messages, synchronization information, or other operating information. In some embodiments, more than one communication bus may be used, and different buses may serve high-bandwidth data traffic, deterministic safety-critical traffic, actuator control traffic, or maintenance/diagnostic traffic.

The control processor 222 may include one or more central processing units, graphics processing units, tensor processors, neural accelerators, field-programmable gate arrays, application-specific integrated circuits, microcontrollers, digital signal processors, or other computing elements configured to execute instructions for perception, recognition-factor generation, fusion, path planning, decision scheduling, control generation, localization, diagnostics, or related functions.

In some embodiments, the control processor 222 may execute one or more software stacks, middleware layers, runtime environments, or real-time operating components that support autonomous operation. The control processor 222 may be centralized or distributed, and different portions of system functionality may be executed by separate processors or accelerator devices.

The sensor interface processor 224 may be configured to receive data from the LiDAR subsystem 204, the radar subsystem 206, the camera subsystem 208, the ultrasonic subsystem 210, the inertial and positioning subsystem 212, or other input devices and to perform one or more input-handling functions before such data is supplied to higher-level modules. In some embodiments, the sensor interface processor 224 may perform timestamping, synchronization, buffering, filtering, packet parsing, image signal processing, range processing, signal conditioning, compression, decompression, calibration correction, coordinate transformation, or format conversion. In certain embodiments, the sensor interface processor 224 may also compute or assist in computing one or more recognition-related inputs, such as sensor-quality estimates, signal-to-noise-related values, confidence values, consistency values, freshness values, or fault indicators, which may later be used by the recognition coverage engine or other recognition-based modules.

The power subsystem 226 may provide electrical power, regulated supply voltages, battery management, charging support, power conditioning, backup power, or emergency power support for the vehicle hardware architecture 200. In some embodiments, the power subsystem 226 may include one or more batteries, fuel-cell interfaces, alternator or generator interfaces, supercapacitors, regulators, converters, isolation components, fuses, thermal protection components, current monitors, or power-distribution elements. The power subsystem 226 may further provide power-status information to the control processor 222 or other modules so that available energy, voltage conditions, or fault conditions can be considered during navigation and task prioritization.

The safety override interface 228 may provide one or more mechanisms by which autonomous operation can be interrupted, limited, overridden, or transitioned into a safe operating mode. In some embodiments, the safety override interface 228 may include a manual takeover input, an emergency stop input, a supervisory-control input, a safety-certified hardware cut-off path, a watchdog-triggered disable path, or other fail-safe mechanisms. The safety override interface 228 may be configured to receive commands from a human operator, a remote supervisor, a safety controller, a diagnostics module, or an onboard emergency logic path. Upon activation, the safety override interface 228 may cause the system to halt motion, reduce speed, disengage autonomous control, hold a current state, transition to a minimum-risk condition, or otherwise modify operation according to a defined safety policy.

The wireless transceiver 230 may support communication between the vehicle hardware architecture 200 and one or more external systems. In some embodiments, the wireless transceiver 230 may support vehicle-to-vehicle communications, vehicle-to-infrastructure communications, cloud connectivity, fleet coordination, remote diagnostics, map updates, cooperative perception, remote teleoperation support, mission updates, or other external exchanges. The wireless transceiver 230 may implement cellular communication, Wi-Fi communication, dedicated short-range communication, satellite communication, mesh-network communication, radio-frequency communication, or any other suitable wireless communication technology. In some embodiments, data received through the wireless transceiver 230 may itself be subject to confidence assessment, recognition-based weighting, trust validation, or security validation before being used by downstream autonomy modules.

In operation, the vehicle hardware architecture 200 may support acquisition of heterogeneous sensor information, synchronization and routing of such information through the vehicle bus 220, and execution of perception, planning, and control logic by the control processor 222 and related computing elements. Sensor data may be supplied through the sensor interface processor 224 to one or more recognition-based subsystems so that quality variations, confidence variations, or other recognition-related variations can be incorporated into downstream navigation functions. Control outputs generated by the control processor 222 may be delivered through appropriate interfaces to the steering actuator 214, the braking actuator 216, and the propulsion actuator 218 so that platform motion can be controlled in accordance with recognition-adjusted perception and decision logic.

In some embodiments, the illustrated sensor set may be modified to suit a particular deployment. For example, a low-cost delivery robot may omit one or more long-range sensors while relying more heavily on cameras, ultrasonic sensing, and inertial sensing. A warehouse robot may employ depth cameras, lidar, wheel odometry, and proximity sensing while omitting long-range radar. A marine vessel may replace certain road-specific sensor placements with hull-mounted sensors, radar arrays, sonar components, inertial navigation components, and marine-positioning inputs. An unmanned aerial vehicle may employ cameras, inertial sensors, GNSS, radar altimeters, and obstacle-detection sensors. The disclosed subject matter is therefore intended to encompass a wide range of hardware combinations and sensor architectures capable of supporting the recognition-based functions described herein.

In some embodiments, one or more sensor modalities may experience degradation due to weather, lighting, dirt accumulation, vibration, interference, occlusion, multipath effects, partial failure, thermal effects, or latency variation. The vehicle hardware architecture 200 may support monitoring of such conditions directly or indirectly through diagnostic outputs, self-test values, confidence estimators, health indicators, or externally computed recognition metrics. Such information may then be used in later-described recognition-based sensor fusion, object detection, planning, or decision logic so that system behavior adapts to real operating conditions rather than relying solely on fixed assumptions about sensor quality.

In further embodiments, calibration information associated with the illustrated hardware components may be stored, updated, or referenced during system operation. For example, intrinsic calibration values, extrinsic calibration values, timing offsets, coordinate transforms, mounting parameters, or bus-latency parameters may be stored and used to align outputs from the LiDAR subsystem 204, radar subsystem 206, camera subsystem 208, ultrasonic subsystem 210, and inertial and positioning subsystem 212. Such calibration values may be static, periodically updated, adaptively adjusted, or validated against safety criteria. As a result, the vehicle hardware architecture 200 may provide a practical hardware foundation for the recognition-based autonomous navigation functions disclosed herein.

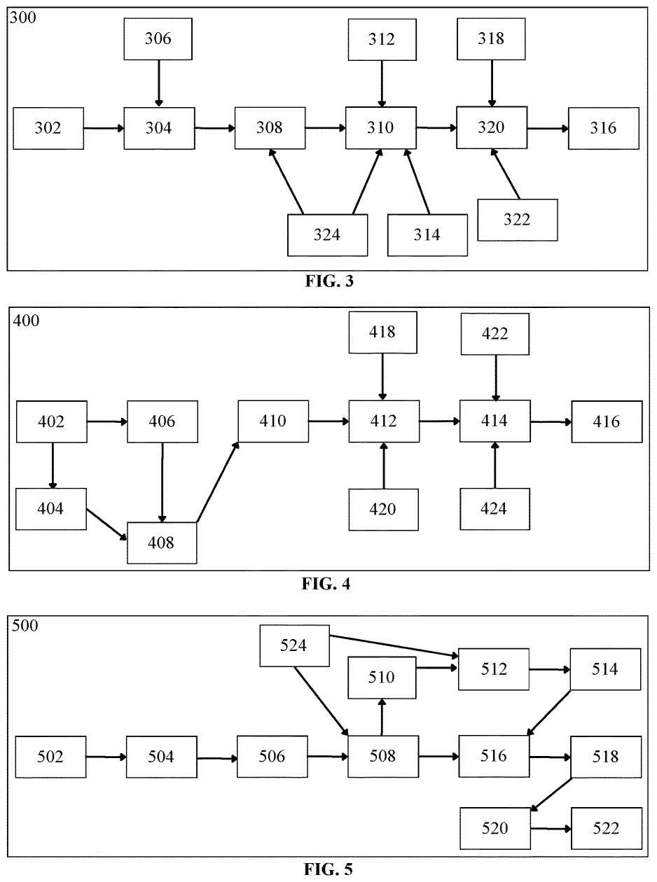

Referring now to FIG. 3, an example recognition coverage subsystem 300 is illustrated. In the illustrated embodiment, the recognition coverage subsystem 300 may include a raw metric input 302, a normalization module 304, a scale or reference store 306, a normalized metric generator 308, a recognition mapping engine 310, a constant store 312, an alternative mapping selector 314, a bounded recognition factor output 316, an approximation module 318, a limit enforcement module 320, a diagnostics module 322, and an update interface 324. Although these elements are shown as separate functional components for clarity, it will be understood that any two or more of such elements may be combined, subdivided, distributed, or implemented differently in other embodiments.

The raw metric input 302 may receive one or more recognition-related values from one or more upstream sources. In various embodiments, the raw metric input 302 may correspond to a reliability value associated with a sensor stream, a confidence value associated with an object detection, an activation-related value associated with a neural inference stage, a traversability value associated with a path-planning element, a free-space confidence value, a map consistency value, a localization confidence value, a risk value associated with a pending control decision, an urgency value, a hazard value, or another quantity associated with the quality, certainty, importance, or operational significance of information being processed within the autonomous navigation system. In some embodiments, the raw metric input 302 may receive a single scalar value. In other embodiments, the raw metric input 302 may receive multiple values that are aggregated, selected, transformed, or otherwise processed to generate one or more recognition metrics.

The normalization module 304 may be configured to transform one or more raw recognition-related values into one or more normalized values suitable for processing by the recognition mapping engine 310. In some embodiments, the normalization module 304 may divide a raw metric by a scale value, reference value, calibration value, baseline value, or expected operating value. For example, in some implementations a normalized recognition metric may be represented as:

r=m/m_scale

where m is a raw recognition-related value and m_scale is a selected scale or reference quantity. In other embodiments, the normalization module 304 may apply offset removal, clipping, range scaling, logarithmic scaling, probabilistic conversion, ratio conversion, statistical normalization, z-score normalization, percentile normalization, sigmoid-like preprocessing, or other normalization approaches. In some embodiments, the normalization module 304 may operate differently for different subsystem types so that sensor-related metrics, neural-activation-related metrics, traversability-related metrics, and risk-related metrics are each normalized using techniques appropriate to their respective data domains.

The scale or reference store 306 may store one or more values used by the normalization module 304 in generating the normalized metric. In some embodiments, the scale or reference store 306 may include one or more fixed constants, learned values, calibrated values, baseline values, threshold values, historical averages, variance values, confidence bounds, normalization tables, or operating-condition-dependent scaling values. In some implementations, different stored values may be associated with different sensors, different sensor modalities, different neural layers, different path-planning representations, different decision classes, or different operational modes. For example, a first scale value may be used to normalize radar reliability values, a second scale value may be used to normalize camera confidence values, a third scale value may be used to normalize path traversability values, and a fourth scale value may be used to normalize collision-risk values.

The normalized metric generator 308 may be configured to produce a normalized recognition metric from the output of the normalization module 304. In some embodiments, the normalized metric generator 308 may produce a nonnegative scalar value suitable for direct processing by the recognition mapping engine 310. In certain embodiments, the normalized recognition metric may be generated from a probability-like input according to the following expression:

r=p/(1−p+epsilon)

where p is a probability-like value and epsilon is a small positive constant used to avoid division by zero or numerical instability. In other embodiments, the normalized metric generator 308 may derive r from confidence intervals, inverse uncertainty values, residual errors, reciprocal variance values, entropy-derived values, consistency measures, margin values, energy values, distance values, or combinations thereof. The normalized metric generator 308 may further clip negative values, reject invalid values, replace undefined values, or otherwise condition the normalized metric before it is provided to the recognition mapping engine 310.

The recognition mapping engine 310 may be configured to generate a bounded recognition factor from the normalized recognition metric. In some preferred embodiments, the recognition mapping engine 310 may implement a recognition coverage function according to the following expression:

F_cov(r; X)=r/(r+X)

where r is a nonnegative normalized recognition metric and X is a positive constant. In such embodiments, the recognition factor may increase as the normalized recognition metric increases while remaining bounded, thereby enabling stable use across multiple modules of the autonomous navigation system. In preferred embodiments, the recognition mapping engine 310 may implement a preferred recognition function according to:

F_pref(r)=r/(r+phi/pi)

where phi is the golden ratio and pi is the circular constant. However, the disclosed subject matter is not limited to this particular constant, and the recognition mapping engine 310 may use other positive constants, calibration values, tunable parameters, or mapping formulations in other embodiments.

The constant store 312 may provide one or more values used by the recognition mapping engine 310 in computing the bounded recognition factor. In some embodiments, the constant store 312 may store a globally shared constant used across multiple recognition-based subsystems. In other embodiments, the constant store 312 may store separate constants for different subsystem categories. For example, a first constant may be used for sensor fusion, a second constant may be used for neural inference or object detection, a third constant may be used for path planning, and a fourth constant may be used for decision prioritization. In some implementations, the constant store 312 may store a preferred constant corresponding to phi/pi together with one or more alternative constants, experimentally derived constants, mode-specific constants, or platform-specific constants. In further embodiments, the constant store 312 may store values corresponding to temperature-dependent settings, weather-dependent settings, speed-dependent settings, payload-dependent settings, or mission-dependent settings.

The alternative mapping selector 314 may be configured to permit selection among multiple bounded recognition-mapping formulations. Although the recognition coverage function described above may be preferred in certain embodiments, other embodiments may implement a generalized mapping, an approximated mapping, or an alternative bounded monotonic transform.

For example, in some embodiments the recognition mapping engine 310 may implement a generalized form according to:

F_gen(r; X, gamma)=r\hat{ }gamma/(r\hat{ }gamma+X\hat{ }gamma)

where gamma is a positive exponent selected to control response shape. In other embodiments, the recognition mapping engine 310 may implement a soft-exponential form such as:

F_soft(r; X)=1−exp(−r/X)

or a logarithmic-bounded form such as:

F_log(r; X)=log(1+r/X)/log(2+r/X)

or another bounded monotonic function suitable for transforming a normalized recognition metric into a recognition factor. The alternative mapping selector 314 may therefore support broader embodiments in which different map shapes are used for different modules, different platforms, different operating conditions, or different certification constraints.

In some embodiments, the recognition coverage engine updates a bounded recognition factor at a cadence selected from 10 Hz to 200 Hz (e.g., 20 Hz, 50 Hz, or 100 Hz) or once per received sensor frame, and may compute the underlying recognition metric using a sliding window having a duration from 50 ms to 2 s (e.g., 100 ms, 250 ms, 500 ms, or 1 s). In certain embodiments, a change-rate limiter constrains a per-update change in the bounded recognition factor to no more than 0.02 to 0.2 in absolute value to reduce oscillation and promote stable downstream control.

The bounded recognition factor output 316 may provide the resulting recognition factor to one or more downstream consumers. In some embodiments, the bounded recognition factor output 316 may provide a scalar recognition factor for use in weighting a sensor stream, scaling a neural activation, modifying a planner cost, or assigning a scheduling priority. In other embodiments, the bounded recognition factor output 316 may provide multiple recognition factors corresponding to multiple sensors, multiple neural channels, multiple graph elements, multiple pending tasks, or multiple candidate decisions. In still further embodiments, the bounded recognition factor output 316 may provide a time-varying stream of recognition factors that are updated continuously, periodically, or event-driven in response to changing inputs.

The approximation module 318 may be configured to reduce computational burden, reduce latency, or improve hardware implementability of the recognition mapping function. In some embodiments, the approximation module 318 may implement a lookup table, a polynomial approximation, a rational approximation, a piecewise-linear approximation, a fixed-point approximation, a quantized implementation, or another reduced-complexity implementation of the selected recognition mapping. Such approximations may be particularly useful in embedded controllers, safety-certified execution contexts, low-power robotic platforms, field-programmable gate array implementations, or other compute-constrained environments. In some embodiments, the approximation module 318 may be selected dynamically based on available resources, required precision, latency targets, or operating mode.

The limit enforcement module 320 may be configured to enforce one or more bounds, constraints, safety conditions, or numerical-stability conditions associated with recognition-factor generation. In some embodiments, the limit enforcement module 320 may clip the normalized metric to a permitted range, clip the recognition factor to a permitted range, enforce nonnegativity of one or more inputs, reject undefined values, replace NaN or infinite values with fallback values, limit rate-of-change of the recognition factor, or constrain one or more constants used by the recognition mapping engine 310. In some implementations, the limit enforcement module 320 may also ensure that a recognition factor used in a safety-critical control pathway remains within a certified envelope or within a previously validated set of allowable values.

The diagnostics module 322 may be configured to generate monitoring outputs associated with the operation of the recognition coverage subsystem 300. In some embodiments, the diagnostics module 322 may report whether incoming values are valid, whether normalization values are stale or out of range, whether mapping constants are within acceptable limits, whether approximation error exceeds a threshold, whether the recognition factor is saturating too frequently, whether input distributions have shifted from expected ranges, or whether subsystem behavior suggests sensor degradation, model drift, calibration drift, or another operating anomaly. Diagnostic outputs from the diagnostics module 322 may be stored locally, transmitted to another subsystem, logged for later review, or used in real time to trigger recalibration, fallback operation, degraded mode, or safety intervention.

The update interface 324 may be configured to receive new constants, new normalization values, new lookup-table entries, new approximation parameters, new thresholds, or other update information associated with the recognition coverage subsystem 300. In some embodiments, the update interface 324 may support offline calibration, periodic parameter refresh, remote update, fleet-based update, simulation-guided tuning, or operator-supervised update. In certain embodiments, the update interface 324 may permit values to be updated only after validation against one or more safety, performance, or stability criteria. In some implementations, the update interface 324 may also support rollback to previous validated settings if a newly introduced value produces undesirable or uncertified behavior.

In operation, the recognition coverage subsystem 300 may receive one or more recognition-related values through the raw metric input 302, may normalize such values using the normalization module 304 and one or more stored values from the scale or reference store 306, may generate a normalized metric using the normalized metric generator 308, and may transform that normalized metric into a bounded recognition factor using the recognition mapping engine 310 and one or more values from the constant store 312. The resulting recognition factor may then be provided through the bounded recognition factor output 316 for use by one or more other subsystems of the autonomous navigation system. Where desired, the alternative mapping selector 314 may select a different mapping formulation, the approximation module 318 may reduce implementation complexity, the limit enforcement module 320 may constrain numerical or safety behavior, the diagnostics module 322 may provide health information, and the update interface 324 may support controlled adjustment of one or more operating parameters.

In some embodiments, the recognition coverage subsystem 300 may operate as a shared service used by multiple downstream modules. For example, the same subsystem may receive a sensor-reliability metric from a fusion pipeline, an activation-magnitude metric from a neural detector, a traversability-confidence metric from a path planner, and a risk metric from a decision scheduler, and may convert each of these into one or more corresponding recognition factors. In other embodiments, multiple separate instances of the recognition coverage subsystem 300 may be provided, such that each subsystem has its own dedicated raw metric input 302, normalization module 304, recognition mapping engine 310, and related support elements. Accordingly, the disclosed subject matter encompasses both centralized and distributed recognition-factor generation architectures.

In some embodiments, the recognition coverage subsystem 300 may be implemented in software executed by one or more general-purpose or specialized processors. In other embodiments, one or more portions of the recognition coverage subsystem 300 may be implemented in firmware, dedicated logic, programmable logic, fixed-function circuitry, analog circuitry, mixed-signal circuitry, or combinations thereof. For example, in a low-latency embodiment, a lookup-table approximation implemented within the approximation module 318 may be executed in an FPGA or ASIC. In another embodiment, an exact closed-form computation may be executed on a CPU or GPU. The disclosed subject matter is therefore not limited to any particular implementation technology.

In further embodiments, the recognition coverage subsystem 300 may be used not only for autonomous navigation but also for related robotic or control tasks in which bounded recognition-based weighting is beneficial. However, in the context of the present disclosure, the recognition coverage subsystem 300 provides a practical and mathematically grounded mechanism for supplying stable recognition factors to navigation-related modules, thereby supporting consistent treatment of confidence, certainty, reliability, and risk across multiple layers of an autonomy stack.

Referring now to FIG. 4, an example recognition-based sensor fusion subsystem 400 is illustrated. The sensor fusion subsystem 400 may be configured to receive multiple sensor-derived inputs and generate a fused perceptual output in which individual sensor contributions are modified according to recognition-based weighting. In the illustrated embodiment, the sensor fusion subsystem 400 may include a sensor input buffer 402, a reliability estimator 404, a component metric extractor 406, a composite recognition metric calculator 408, a recognition weight generator 410, a weighted fusion engine 412, a fusion normalizer 414, a fused percept output 416, a fault handling module 418, a covariance estimator 420, a temporal filter 422, and a downstream perception interface 424. Although these elements are shown as separate functional blocks for ease of illustration, it will be understood that one or more of such elements may be combined, subdivided, reordered, distributed, or otherwise implemented differently in other embodiments.

The sensor input buffer 402 may be configured to receive, store, align, and provide sensor-derived inputs to downstream components of the sensor fusion subsystem 400. In various embodiments, the sensor input buffer 402 may receive raw sensor data, preprocessed sensor data, feature-level representations, object-level representations, track-level representations, occupancy values, depth values, free-space values, segmentation outputs, localization-related values, or combinations thereof from one or more sensing modalities. In some embodiments, such sensing modalities may include LiDAR, radar, cameras, ultrasonic sensing, inertial sensors, positioning sensors, odometry sources, event sensors, thermal sensors, sonar sensors, or other sensor systems suitable for a given platform. The sensor input buffer 402 may further timestamp, queue, synchronize, organize, or otherwise prepare such incoming information for reliability assessment and fusion processing.

The reliability estimator 404 may be configured to determine one or more reliability-related values associated with one or more incoming sensor streams or sensor-derived representations. In some embodiments, the reliability estimator 404 may evaluate signal quality, confidence, freshness, latency, packet completeness, noise level, environmental suitability, historical consistency, fault state, obstruction state, or self-diagnostic information. By way of example, the reliability estimator 404 may determine that a camera stream is degraded under low-light or glare conditions, that a radar stream is more reliable under rain or fog conditions, that a LiDAR stream is partially degraded by contamination or weather interference, or that an ultrasonic stream is particularly informative for near-field operations. The reliability estimator 404 may produce scalar reliability values, vectors of component values, categorical states, confidence scores, or other outputs suitable for further processing.

The component metric extractor 406 may be configured to derive one or more recognition-related component metrics from the outputs of the reliability estimator 404 or directly from one or more buffered inputs. In some embodiments, the component metric extractor 406 may derive values associated with signal-to-noise ratio, detection stability, object-track continuity, frame recency, residual error, calibration consistency, sensor health, environmental fit, observation density, or other characteristics relevant to determining the usefulness of a particular sensor contribution. In some implementations, the component metric extractor 406 may generate multiple values for a single sensor modality, such as separate quality values for range quality, angular quality, classification quality, and timing quality. In this manner, the component metric extractor 406 may support richer recognition-based weighting than a single coarse confidence value.

The composite recognition metric calculator 408 may be configured to combine one or more component metrics into a composite recognition metric suitable for conversion into a recognition weight. In some embodiments, the composite recognition metric calculator 408 may generate a composite score according to a weighted sum, average, geometric mean, product, rule-based combination, learned combination, or other aggregation technique. In one example embodiment, a composite recognition metric may be represented as:

C_i=sum_j(k_j*q_ij)

where C_i is a composite recognition metric for a sensor stream or representation i, q_ij represents a component metric j associated with that stream or representation, and k_j represents a corresponding weighting value. In some embodiments, equal weighting may be used. In other embodiments, different component metrics may be assigned different weights depending on deployment context, platform type, safety relevance, or empirical performance. The composite recognition metric calculator 408 may therefore support simple and complex reliability constructions alike.

The recognition weight generator 410 may be configured to generate one or more recognition-based weights from the composite recognition metric produced by the composite recognition metric calculator 408. In some embodiments, the recognition weight generator 410 may receive a normalized recognition metric and may generate a bounded recognition weight using a recognition mapping function of the type described above with respect to FIG. 3. In one example, the recognition weight may be expressed as:

w_i=F_cov(C_i; X_fuse)

where w_i is a recognition-based weight associated with sensor stream or representation i, C_i is a recognition-related metric or normalized metric associated with that stream or representation, and X_fuse is a positive constant or parameter used for the sensor fusion context. In some preferred embodiments, X_fuse may correspond to a preferred constant such as phi/pi. In other embodiments, X_fuse may be selected differently for different sensor types, operating modes, or platform conditions. The resulting weight may be bounded and may increase as the corresponding recognition metric increases, thereby supporting controlled influence of more reliable information sources.

The weighted fusion engine 412 may be configured to combine multiple sensor streams or sensor-derived representations using one or more recognition-based weights generated by the recognition weight generator 410. In some embodiments, the weighted fusion engine 412 may perform low-level sensor fusion, feature-level fusion, object-level fusion, track-level fusion, occupancy fusion, free-space fusion, semantic fusion, or combinations thereof. In some implementations, the weighted fusion engine 412 may generate a fused representation according to an expression of the form:

S_fused=(sum_i(w_i*S_i))/(sum_i(w_i)+epsilon_f)

where S_i represents a sensor-derived quantity or representation associated with stream i, w_i represents a corresponding recognition-based weight, and epsilon_f is a small positive constant used for numerical stability. In other embodiments, the weighted fusion engine 412 may implement weighted covariance fusion, Kalman-style update fusion, particle-based fusion, belief fusion, evidential fusion, occupancy-grid fusion, graph-based fusion, attention-based fusion, or learned multi-modal fusion. The disclosed subject matter is not limited to any particular fusion algorithm so long as one or more recognition-derived values are used to modify the contribution of one or more inputs.

The fusion normalizer 414 may be configured to normalize, scale, regularize, bound, or otherwise condition the output of the weighted fusion engine 412. In some embodiments, the fusion normalizer 414 may ensure that the fused output remains within a defined value range, that the resulting representation maintains expected dimensional or probabilistic properties, or that normalization is applied after weighted aggregation. In some implementations, the fusion normalizer 414 may normalize confidence maps, occupancy values, belief values, probability-like values, semantic weights, feature magnitudes, or track confidences. The fusion normalizer 414 may also correct for changes in total input weight, missing modalities, or low-confidence operating modes so that downstream modules receive stable and interpretable fused outputs.

The fused percept output 416 may provide the resulting fused perceptual representation to one or more downstream modules. In some embodiments, the fused percept output 416 may correspond to a fused point cloud, a fused object list, a fused occupancy map, a fused free-space map, a fused semantic map, a fused track set, a fused scene representation, or another perception-related output suitable for downstream use. Such outputs may be provided to an object detection subsystem, a path planning subsystem, a decision engine, a localization or mapping subsystem, a control module, or other autonomy functions. In certain embodiments, the fused percept output 416 may include metadata indicating confidence levels, source contributions, sensor-availability status, or recognition-weight status associated with portions of the fused representation.

The fault handling module 418 may be configured to detect, isolate, flag, suppress, or otherwise manage faults or degraded conditions associated with one or more sensor inputs. In some embodiments, the fault handling module 418 may detect sensor dropout, stale data, calibration mismatch, excessive latency, implausible measurements, persistent disagreement between modalities, or hardware self-test failures. Upon detecting such a condition, the fault handling module 418 may reduce a corresponding recognition weight, exclude a sensor input from the current fusion cycle, trigger a degraded-mode policy, generate a diagnostic output, or request a fallback operating mode. In some embodiments, the fault handling module 418 may cooperate with the reliability estimator 404 so that reliability values and explicit fault states jointly influence the final recognition-based weighting applied during fusion.

The covariance estimator 420 may be configured to estimate, update, store, or propagate uncertainty-related information associated with one or more sensor streams or with the fused output itself. In some embodiments, the covariance estimator 420 may generate covariance matrices, variance values, uncertainty bounds, residual distributions, confidence ellipses, or similar uncertainty representations. Such information may be used by the weighted fusion engine 412, the fusion normalizer 414, or downstream modules in connection with Kalman-type fusion, Bayesian fusion, track management, map updating, motion estimation, or decision prioritization. In some implementations, the covariance estimator 420 may also supply one or more uncertainty-derived values that contribute to the recognition-related metrics used by the recognition weight generator 410.

The temporal filter 422 may be configured to smooth, stabilize, align, or otherwise process sensor-derived and fused information across time. In some embodiments, the temporal filter 422 may reduce flicker, suppress transient anomalies, improve track continuity, or provide temporal consistency for perception outputs. The temporal filter 422 may implement exponential smoothing, moving averages, recursive filters, Kalman filters, particle filters, temporal attention, recurrent architectures, or other temporal-processing mechanisms. In some embodiments, the temporal filter 422 may account for asynchronous sensor arrival times, sensor-specific update rates, variable latency, delayed packets, or time-offset compensation so that data from different modalities may still be incorporated coherently into the fusion process.

The downstream perception interface 424 may be configured to supply one or more outputs of the sensor fusion subsystem 400 to one or more additional modules within the autonomous navigation system. In some embodiments, the downstream perception interface 424 may provide a fused perceptual representation to an object detection subsystem, a scene-understanding subsystem, a path planning subsystem, a prediction subsystem, a localization subsystem, a mapping subsystem, or a decision engine. In some implementations, the downstream perception interface 424 may provide multiple versions of a fused output, such as a high-resolution local representation, a lower-resolution global representation, a confidence-annotated representation, or a subsystem-specific representation optimized for a particular downstream consumer.

In operation, the sensor fusion subsystem 400 may receive multiple sensor-derived inputs through the sensor input buffer 402, may estimate reliability or related recognition information using the reliability estimator 404 and the component metric extractor 406, may generate a composite recognition metric using the composite recognition metric calculator 408, and may convert that metric into one or more recognition-based weights using the recognition weight generator 410. The weighted fusion engine 412 may then use such weights to combine sensor data or sensor-derived representations into a fused perceptual output, after which the fusion normalizer 414, the fault handling module 418, the covariance estimator 420, and the temporal filter 422 may further condition, stabilize, validate, or annotate the fused result. The resulting fused percept output 416 may then be supplied through the downstream perception interface 424 to one or more downstream modules.

In some embodiments, the sensor fusion subsystem 400 may operate at different levels of abstraction. For example, low-level fusion may combine raw or lightly processed measurements from multiple sensor modalities. Feature-level fusion may combine learned feature maps or intermediate encoded representations from different modalities. Object-level fusion may combine detected objects, object hypotheses, or classification results. Track-level fusion may combine object tracks maintained across time. Occupancy-level fusion may combine free-space or occupancy information, and semantic fusion may combine environmental labels or scene interpretations. The disclosed subject matter is intended to encompass each such level of fusion so long as one or more recognition-derived values are used to influence the relative contribution of one or more sources.

In some embodiments, the sensor fusion subsystem 400 may use different recognition metrics for different modalities or for different parts of a scene. For example, one region of a fused environment map may rely more heavily on radar information under poor-visibility conditions, whereas another region may rely more heavily on camera or LiDAR information when visibility and sensing conditions favor those modalities. In some embodiments, recognition-based weighting may be spatially varying, temporally varying, object-specific, feature-specific, or modality-specific. Thus, the disclosed architecture is not limited to assigning a single fixed weight to an entire sensor stream, but instead may support fine-grained weighting across space, time, objects, features, or tasks.

In further embodiments, the sensor fusion subsystem 400 may be used together with one or more learned or adaptive modules. For example, a neural fusion architecture may produce intermediate feature representations from different sensors, and the recognition weight generator 410 may provide one or more scaling factors or gating values used within the learned fusion architecture. In another embodiment, a probabilistic fusion engine may use recognition-derived weights to modify covariance structures, update gains, or trust levels associated with different information sources. In still another embodiment, recognition-based weighting may be combined with rule-based exclusions, safety constraints, or regulatory constraints. Accordingly, the disclosed subject matter encompasses both model-based and learned fusion implementations.

Referring now to FIG. 5, an example recognition-optimized object detection subsystem 500 is illustrated. The object detection subsystem 500 may be configured to apply one or more recognition-based factors to one or more neural inference values, activation values, feature values, or detection-related quantities in order to improve perception processing under changing operating conditions. In the illustrated embodiment, the object detection subsystem 500 may include an input data tensor 502, a backbone network 504, a feature extraction stage 506, an activation generation stage 508, an activation magnitude module 510, a recognition scaling module 512, a scaled activation output 514, a detection head 516, a classification and localization output 518, a post-processing module 520, a detected object output 522, and a training or update interface 524. Although FIG. 5 illustrates one example arrangement, it will be understood that one or more illustrated elements may be combined, subdivided, repeated, omitted, reordered, or otherwise implemented differently in other embodiments.

The input data tensor 502 may be configured to provide one or more perception-related inputs to the object detection subsystem 500. In various embodiments, the input data tensor 502 may include image data, multi-channel image data, fused sensor data, depth representations, point-cloud-derived projections, radar-derived tensors, occupancy-derived tensors, semantic tensors, feature tensors, or other structured input representations suitable for use by a neural network or other perception engine. In some embodiments, the input data tensor 502 may be generated directly from the camera subsystem, from a fused output produced by the recognition-based sensor fusion subsystem, or from a preprocessing pipeline configured to align, crop, normalize, augment, encode, or otherwise prepare raw sensor information for inference. In some implementations, the input data tensor 502 may include spatial dimensions, channel dimensions, temporal dimensions, modality dimensions, or combinations thereof.

The backbone network 504 may be configured to receive the input data tensor 502 and generate one or more intermediate feature representations. In some embodiments, the backbone network 504 may include a convolutional neural network, a transformer-based network, a hybrid convolution-transformer network, a residual network, a feature pyramid network component, a vision transformer, a recurrent perception network, a spiking or event-based network, or another learned architecture suitable for extracting representations useful for object detection, segmentation, classification, tracking, or scene understanding. The backbone network 504 may include multiple stages, blocks, layers, or branches, and may generate hierarchical features corresponding to different spatial resolutions, receptive fields, semantic levels, or temporal contexts.

The feature extraction stage 506 may be configured to generate, refine, aggregate, or organize one or more learned feature maps or latent representations derived from the backbone network 504. In some embodiments, the feature extraction stage 506 may include multi-scale feature extraction, pyramid construction, lateral connections, feature aggregation, feature compression, attention-based refinement, context integration, or cross-modal fusion. The feature extraction stage 506 may produce features associated with object boundaries, texture, geometry, motion, semantic class cues, depth cues, free-space cues, or contextual cues. In some implementations, the feature extraction stage 506 may operate across multiple sensing modalities and may provide modality-combined feature representations to later stages of the object detection subsystem 500.

The activation generation stage 508 may be configured to generate one or more activations, response values, logits, objectness values, channel responses, attention responses, intermediate detections, or related inference values from the features produced by the feature extraction stage 506. In some embodiments, the activation generation stage 508 may correspond to one or more neural layers, heads, decoders, proposal networks, classifier branches, regressor branches, segmentation branches, or tracker-associated branches. The activation generation stage 508 may therefore produce raw internal values that, if used directly, may include both highly informative responses and weak, noisy, unstable, or low-information responses. The disclosed subject matter recognizes that such internal values may be improved by applying one or more recognition-based factors before downstream interpretation or thresholding.

The activation magnitude module 510 may be configured to determine a magnitude-related metric associated with one or more values generated by the activation generation stage 508. In some embodiments, the activation magnitude module 510 may compute absolute activation magnitude, norm-based magnitude, channel energy, confidence-related magnitude, margin-based magnitude, entropy-derived magnitude, spatial aggregate magnitude, region-specific magnitude, temporal persistence magnitude, or combinations thereof. In one example embodiment, the magnitude-related value may be expressed as:

A_mag=abs(A_raw)

where A_raw is a raw activation value or other inference-related value. In other embodiments, the activation magnitude module 510 may compute a vector norm, a tensor norm, an averaged magnitude, a maximum magnitude, a probability-derived metric, an uncertainty-inverse metric, or another quantity suitable for use as a recognition-related metric. In some implementations, different activation magnitude calculations may be used for different layers, channels, object classes, or perception tasks.

The recognition scaling module 512 may be configured to generate and apply one or more recognition-based scaling factors to one or more activation-related quantities. In some embodiments, the recognition scaling module 512 may receive one or more activation magnitude values from the activation magnitude module 510, may normalize such values if appropriate, and may generate a bounded recognition factor using a recognition mapping function such as the recognition coverage function described elsewhere herein. In one example embodiment, a scaled activation may be expressed as:

A_scaled=A_raw*F_cov(A_mag; X_det)

where A_scaled is a recognition-scaled activation value, A_raw is the raw activation value, A_mag is a magnitude-related recognition metric associated with that activation, and X_det is a positive constant or parameter selected for the object-detection context. In some preferred embodiments, X_det may correspond to a preferred constant such as phi/pi. In other embodiments, X_det may differ by layer, branch, object class, operating mode, platform type, or environmental condition.

In some embodiments, the recognition scaling module 512 may apply the recognition factor not only to raw activations, but also to pre-activations, intermediate feature values, channel gates, attention values, objectness values, class logits, regression-confidence values, segmentation responses, tracking-association scores, or other internal or external quantities generated by the object detection subsystem 500. In some implementations, stronger, more informative, or more stable values may be preserved or emphasized, while weaker, unstable, low-confidence, or noisy values may be relatively suppressed. In this way, the object detection subsystem 500 may reduce propagation of low-value internal responses that otherwise could contribute to false detections, unstable outputs, or unnecessary downstream processing.

The scaled activation output 514 may provide one or more scaled activations, scaled feature values, scaled logits, scaled confidence values, or other recognition-adjusted inference values to one or more downstream portions of the object detection subsystem 500. In some embodiments, the scaled activation output 514 may preserve spatial structure, channel structure, temporal structure, proposal structure, or class-specific structure associated with the underlying activation values. In some implementations, the scaled activation output 514 may be supplied directly to the detection head 516. In other implementations, multiple scaled activation outputs may be produced for use by different branches or different downstream tasks.

The detection head 516 may be configured to convert one or more scaled or otherwise processed representations into detection-related outputs. In some embodiments, the detection head 516 may include one or more classification heads, localization heads, bounding-box regression heads, keypoint heads, mask heads, semantic segmentation heads, panoptic heads, objectness heads, tracking heads, trajectory-prediction heads, or combinations thereof. The detection head 516 may generate candidate detections, class scores, objectness scores, bounding boxes, masks, keypoints, track associations, motion estimates, or other outputs relevant to the perception function of the autonomous navigation system. In some embodiments, the detection head 516 may itself incorporate one or more recognition-based scaling steps internally.

The classification and localization output 518 may be configured to provide raw or intermediate perception outputs generated by the detection head 516. In some embodiments, the classification and localization output 518 may include class labels, class probabilities, confidence values, bounding-box coordinates, oriented boxes, three-dimensional boxes, segmentation masks, depth-aware object outputs, motion vectors, track identifiers, or related inference products. In some implementations, the classification and localization output 518 may provide outputs for static objects, dynamic objects, road features, lane features, traffic-control elements, pedestrians, animals, vehicles, obstacles, infrastructure elements, or other scene elements relevant to autonomous navigation.

The post-processing module 520 may be configured to refine, filter, combine, threshold, rank, associate, smooth, or otherwise process outputs generated by the detection head 516 and the classification and localization output 518. In some embodiments, the post-processing module 520 may perform thresholding, non-maximum suppression, soft non-maximum suppression, box fusion, class filtering, track association, temporal smoothing, confidence calibration, duplicate removal, geometry filtering, range filtering, plausibility filtering, or rule-based validation. In some implementations, the post-processing module 520 may itself employ one or more recognition-derived values in setting thresholds, ranking candidates, suppressing weak detections, or calibrating output confidence. Thus, recognition-based processing may occur not only within earlier neural layers, but also within downstream output conditioning stages.

The detected object output 522 may provide the final or intermediate object detection results to one or more downstream modules of the autonomous navigation system. In some embodiments, the detected object output 522 may include one or more object lists, track lists, semantic scene annotations, occupancy annotations, obstacle descriptions, class-confidence sets, spatial-localization data, or combinations thereof. Such outputs may be supplied to a path planning subsystem, a decision engine, a localization or mapping subsystem, a prediction subsystem, a control module, or another consumer. In some embodiments, the detected object output 522 may include metadata indicating confidence levels, recognition-scaling values, detection provenance, modality contributions, uncertainty values, or temporal stability measures associated with one or more detected objects.

The training or update interface 524 may be configured to support training-time configuration, inference-time configuration, parameter updates, calibration updates, model replacement, threshold updates, or operating-mode changes associated with the object detection subsystem 500. In some embodiments, the training or update interface 524 may permit the recognition scaling module 512 to be incorporated during training so that the network learns under recognition-adjusted activation conditions. In other embodiments, the training or update interface 524 may support inference-only insertion of the recognition-based scaling logic into an otherwise pre-trained network. In some implementations, the training or update interface 524 may support different deployment modes, including high-accuracy mode, low-latency mode, low-power mode, adverse-weather mode, or safety-conservative mode.

In operation, the object detection subsystem 500 may receive one or more structured perception inputs through the input data tensor 502, may generate one or more learned feature representations using the backbone network 504 and the feature extraction stage 506, and may generate one or more activation-related values using the activation generation stage 508. The activation magnitude module 510 may determine one or more recognition-related metrics associated with such activation-related values, and the recognition scaling module 512 may generate and apply one or more recognition-based scaling factors so that downstream inference emphasizes stronger or more reliable responses and suppresses weaker or lower-value responses. The resulting scaled activation output 514 may then be processed by the detection head 516, the classification and localization output 518, and the post-processing module 520 to generate a detected object output 522 suitable for downstream navigation functions.

In some embodiments, the object detection subsystem 500 may be used with a one-stage detector, a two-stage detector, a proposal-based detector, an anchor-based detector, an anchor-free detector, a transformer-based detector, a segmentation-oriented detector, a multi-task perception network, a tracking-by-detection architecture, or other perception architecture. In some embodiments, recognition-based scaling may be applied at only one stage of the network. In other embodiments, recognition-based scaling may be applied at multiple stages, including early feature extraction, intermediate feature aggregation, late-stage logits, and post-processing outputs. The disclosed subject matter is intended to encompass each such arrangement.

In some embodiments, the recognition-related metric used by the recognition scaling module 512 may be derived from activation magnitude alone. In other embodiments, the recognition-related metric may incorporate additional information such as feature consistency, temporal persistence, cross-modal agreement, confidence calibration, uncertainty inverse, spatial context, localization stability, or environmental suitability. By way of example, an activation may be assigned a higher recognition-related value when it persists coherently across frames, aligns with another sensing modality, and produces a stable localization estimate, and may be assigned a lower recognition-related value when it appears transient, weak, inconsistent, or unsupported by surrounding context. Accordingly, the disclosed architecture is not limited to simple single-variable activation scaling.

In further embodiments, the object detection subsystem 500 may support object detection, semantic segmentation, instance segmentation, panoptic segmentation, keypoint estimation, free-space estimation, lane detection, road-boundary detection, object tracking, or multi-task scene understanding. One or more recognition-based scaling operations may be used in any such task wherever it is beneficial to modulate internal or output values according to bounded recognition-related information. Thus, while FIG. 5 is described in the context of object detection, the disclosed subject matter also supports broader recognition-optimized perception embodiments.

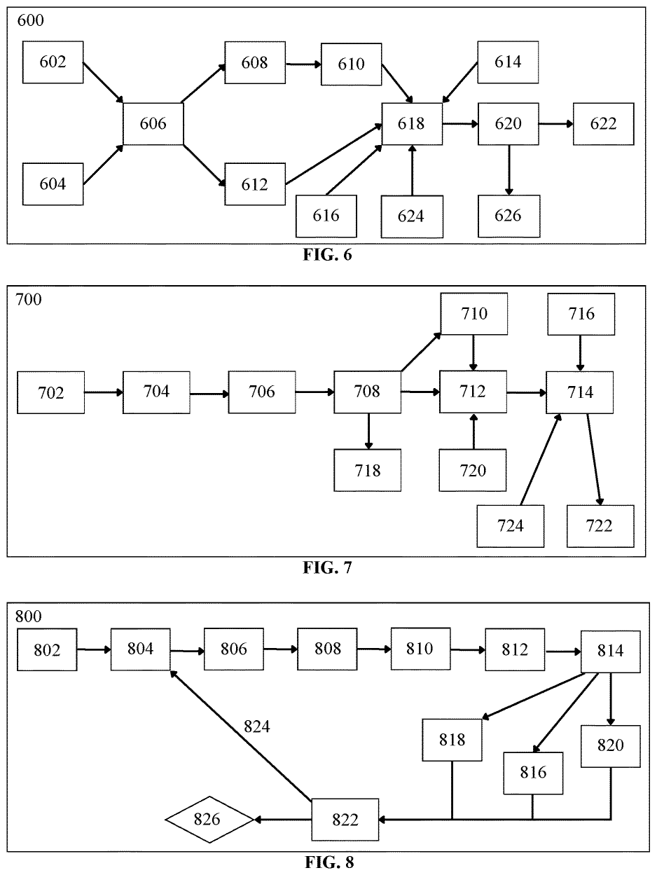

Referring now to FIG. 6, an example recognition-based path planning subsystem 600 is illustrated. The path planning subsystem 600 may be configured to generate one or more candidate paths, trajectories, or navigational actions in which cost values are modified according to recognition-derived information associated with traversability, certainty, clearance, or related environmental conditions. In the illustrated embodiment, the path planning subsystem 600 may include a map input 602, a pose input 604, a graph or lattice generator 606, a traversability estimator 608, a recognition cost module 610, a node cost store 612, a transition cost module 614, a heuristic module 616, a planner engine 618, a trajectory refinement module 620, a planned path output 622, a dynamic obstacle update module 624, and a local control interface 626. Although FIG. 6 illustrates one example arrangement, it will be understood that one or more illustrated components may be combined, subdivided, reordered, repeated, distributed, or otherwise implemented differently in other embodiments.

The map input 602 may be configured to provide environmental representation data to the path planning subsystem 600. In various embodiments, the map input 602 may include a prebuilt map, an online-generated map, an occupancy grid, a free-space map, a lane graph, a road-network representation, a topological graph, a voxel map, a semantic map, a traversability map, a cost map, or another representation of the surrounding environment suitable for navigation planning. In some embodiments, the map input 602 may incorporate static environmental information such as roads, lanes, boundaries, intersections, fixed obstacles, drivable regions, or structural geometry. In other embodiments, the map input 602 may incorporate dynamic or semi-dynamic information such as temporary blockages, construction zones, movable objects, weather-dependent route conditions, or live updates supplied by onboard sensing, cooperative perception, or remote infrastructure.

The pose input 604 may be configured to provide a current or estimated state of the autonomous platform to the path planning subsystem 600. In some embodiments, the pose input 604 may include position, orientation, heading, velocity, acceleration, angular rate, uncertainty values, predicted state, or combinations thereof. In some implementations, the pose input 604 may be provided by a localization subsystem, inertial subsystem, GNSS subsystem, odometry subsystem, SLAM subsystem, or fused positioning engine. The pose input 604 may be used together with the map input 602 to determine a current planning state, a start node, an initial trajectory state, a current lane position, or another initialization condition for the planning process.

The graph or lattice generator 606 may be configured to construct, derive, select, or update a planning representation from the map input 602 and the pose input 604. In some embodiments, the graph or lattice generator 606 may generate a graph of nodes and edges, a motion lattice, a waypoint network, a spline set, a sampled trajectory set, a voxelized planning space, a lane-level connectivity structure, or another path-search representation suitable for planning. In some implementations, the graph or lattice generator 606 may generate candidate states associated with steering angles, headings, velocities, curvature values, motion primitives, or kinematic constraints of the underlying platform. In certain embodiments, the graph or lattice generator 606 may generate different representations for global planning and local planning, or may update the planning representation continuously as new environmental information becomes available.

The traversability estimator 608 may be configured to determine one or more recognition-related values associated with the suitability of nodes, cells, edges, trajectories, or navigational regions for traversal. In some embodiments, the traversability estimator 608 may evaluate free-space confidence, obstacle certainty, terrain quality, lane availability, rule compliance, map consistency, localization confidence, dynamic-object prediction, road-surface condition, weather effect, slope, clutter, or combinations thereof. In some implementations, the traversability estimator 608 may generate a scalar traversability value for a node or edge. In other implementations, the traversability estimator 608 may generate multiple component values that are later combined into a recognition-related planning metric. For example, a region may receive a higher traversability-related value when it appears open, well-localized, map-consistent, and free of predicted conflicts, and may receive a lower value when it appears uncertain, obstructed, weakly observed, or dynamically hazardous.

The recognition cost module 610 may be configured to modify one or more planning costs using a bounded recognition factor derived from one or more traversability-related or certainty-related metrics. In some embodiments, the recognition cost module 610 may receive a traversability confidence value, clearance confidence value, free-space probability value, or similar planning-related recognition metric and may transform such value into a recognition factor using the recognition coverage function or another bounded mapping. In one example embodiment, a recognition-adjusted node cost may be represented as:

Cost_rec(n)=Cost_base(n)*(1−F_cov(D_n; X_path))

where Cost_rec(n) is a recognition-adjusted cost associated with node n, Cost_base(n) is a base cost associated with the node, D_n is a traversability-related or certainty-related metric associated with that node, and X_path is a positive constant or parameter selected for the path-planning context. In some preferred embodiments, X_path may correspond to a preferred constant such as phi/pi. In other embodiments, other constants, parameters, or mapping functions may be used.

In another example embodiment, the recognition cost module 610 may generate an edge-based adjusted cost according to:

Cost_edge_rec(e)=Cost_edge(e)*(1−F_cov(D_e; X_path))

where Cost_edge_rec(e) is a recognition-adjusted edge cost, Cost_edge(e) is a base edge cost, and D_e is a recognition-related metric associated with the edge. In this manner, paths associated with higher verified clearance, higher traversability confidence, or stronger environmental certainty may be assigned lower effective costs than paths associated with lower certainty, reduced visibility, higher hazard, or greater uncertainty. In some embodiments, the recognition cost module 610 may apply recognition adjustment to nodes only, edges only, trajectories only, or combinations thereof.

The node cost store 612 may be configured to store one or more base costs, recognition-adjusted costs, historical costs, updated costs, or related planning values associated with nodes, cells, voxels, waypoints, or other planning elements. In some embodiments, the node cost store 612 may maintain a cost map, node table, voxel table, lane-state table, or another structure in which one or more planning costs are stored and updated. In some implementations, the node cost store 612 may also store metadata indicating the source of a cost contribution, the last update time, the confidence level associated with a cost value, or whether a node has been invalidated, expanded, or reserved during a planning cycle.

The transition cost module 614 may be configured to determine costs associated with transitions between planning states. In some embodiments, the transition cost module 614 may evaluate path length, curvature, steering effort, control smoothness, dynamic feasibility, acceleration limits, jerk limits, rule compliance, collision risk, obstacle proximity, or other path-transition characteristics. The transition cost module 614 may also incorporate recognition-derived information, such as uncertainty associated with a transition, predicted occupancy conflict, or confidence associated with dynamic-obstacle forecasts. In some implementations, the recognition-adjusted total planning cost may be expressed as:

Cost_total(path)=sum(Cost_rec(n))+alpha*Cost_trans+beta*Cost_dyn+delta*Cost_rule

where Cost_trans represents one or more transition-related penalties, Cost_dyn represents one or more dynamic-obstacle-related penalties, Cost_rule represents one or more rule-related penalties, and alpha, beta, and delta are weighting values. In other embodiments, other total-cost formulations may be used.

The heuristic module 616 may be configured to provide one or more heuristic values, guidance values, admissible estimates, ranking values, or search-priority values used by the planner engine 618. In some embodiments, the heuristic module 616 may estimate a remaining distance to goal, a time-to-go value, an energy-to-go value, a cost-to-go value, a lane-change penalty, a motion-feasibility value, or another planning-guidance quantity. In some implementations, the heuristic module 616 may itself incorporate recognition-based information so that the planner favors regions or trajectories associated with greater certainty or lower uncertainty. In other embodiments, the heuristic module 616 may remain recognition-neutral while only the actual path costs are recognition-adjusted.

The planner engine 618 may be configured to search, rank, optimize, sample, or otherwise determine one or more candidate paths or trajectories based on inputs received from the graph or lattice generator 606, the recognition cost module 610, the node cost store 612, the transition cost module 614, and the heuristic module 616. In some embodiments, the planner engine 618 may implement A*, D*, D* Lite, Hybrid A*, graph search, lattice search, RRT, RRT*, PRM, trajectory optimization, model predictive control, dynamic programming, local reactive planning, or another planning approach. In some implementations, the planner engine 618 may support both global planning and local planning. The planner engine 618 may therefore determine a path or trajectory that satisfies kinematic, dynamic, safety, and mission constraints while also accounting for recognition-adjusted environmental suitability.

The trajectory refinement module 620 may be configured to smooth, reparameterize, regularize, densify, simplify, or otherwise improve a selected path or trajectory generated by the planner engine 618. In some embodiments, the trajectory refinement module 620 may reduce curvature discontinuities, improve control smoothness, enforce platform-specific kinematic constraints, increase passenger comfort, increase tracking stability, or refine path feasibility for downstream controllers. In some implementations, the trajectory refinement module 620 may convert a discrete path into a spline, polynomial trajectory, time-parameterized trajectory, or control-command sequence. The trajectory refinement module 620 may also preserve or further adjust recognition-related preferences embedded in the selected path.

The planned path output 622 may be configured to provide one or more selected planning outputs to one or more downstream modules. In some embodiments, the planned path output 622 may include a waypoint sequence, a lane-level route, a local trajectory, a time-parameterized trajectory, a spline path, a control sequence, or another navigational output suitable for use by a downstream controller or decision engine. In some implementations, the planned path output 622 may include metadata indicating path confidence, path cost, recognition-derived contributions, expected hazard levels, alternative-path rankings, or replan triggers associated with the selected path.

The dynamic obstacle update module 624 may be configured to update the planning process based on new or revised information associated with moving or changing obstacles. In some embodiments, the dynamic obstacle update module 624 may receive object tracks, motion predictions, occupancy forecasts, cooperative perception updates, or new sensed observations and may modify node availability, edge availability, traversability values, or path costs accordingly. In some implementations, the dynamic obstacle update module 624 may trigger partial replanning, full replanning, local obstacle avoidance, or minimum-risk fallback behavior when dynamic hazards change sufficiently. The dynamic obstacle update module 624 may therefore support responsive path updates under real-world traffic or robotic operating conditions.

The local control interface 626 may be configured to provide the selected path, trajectory, or planning command to one or more downstream control modules. In some embodiments, the local control interface 626 may provide steering references, speed targets, acceleration targets, yaw targets, thrust targets, waypoint commands, or other motion-control information. In some implementations, the local control interface 626 may provide a local plan to a lower-level motion controller while also providing status or confidence information to a decision engine or safety monitor. Thus, the path planning subsystem 600 may operate as an intermediate planning layer between perception and actuation.

In operation, the path planning subsystem 600 may receive environmental information through the map input 602 and platform state information through the pose input 604, may construct or update a planning representation using the graph or lattice generator 606, and may evaluate traversability or certainty information using the traversability estimator 608. The recognition cost module 610 may then determine recognition-adjusted planning costs based on one or more recognition-related metrics, and the planner engine 618 may use such costs together with values from the node cost store 612, the transition cost module 614, and the heuristic module 616 to select one or more candidate paths or trajectories. The selected output may then be refined by the trajectory refinement module 620, provided through the planned path output 622, and updated as needed by the dynamic obstacle update module 624 before being supplied through the local control interface 626.

In some embodiments, the path planning subsystem 600 may operate on a two-dimensional planning surface. In other embodiments, the path planning subsystem 600 may operate in a three-dimensional environment, such as for unmanned aerial vehicles, underwater vehicles, or other platforms with non-planar motion. In some implementations, planning may occur in a lane graph, a waypoint graph, a voxel grid, a free-space representation, a state lattice, or a trajectory sample space. The disclosed subject matter is intended to encompass each such representation so long as recognition-derived information is used to influence path evaluation, path ranking, or path selection.

In some embodiments, the recognition-related metric used by the recognition cost module 610 may be derived from a single traversability-related value. In other embodiments, the recognition-related metric may be derived from multiple values, including free-space confidence, map consistency, localization certainty, dynamic obstacle prediction certainty, road-surface condition, visibility quality, or cooperative-perception support. By way of example, a candidate route may be favored not merely because it is geometrically short, but because it is associated with more reliable sensing coverage, better map agreement, lower uncertainty, and stronger evidence of safe clearance. Accordingly, the path planning subsystem 600 may provide more robust route selection than systems that rely only on static geometric cost.

In further embodiments, the path planning subsystem 600 may cooperate with rule-based safety logic, policy constraints, mission constraints, or operator instructions. For example, a shortest path may be rejected in favor of a slightly longer route if the longer route is associated with higher traversability certainty or lower recognition-adjusted risk. In another embodiment, the planner engine 618 may generate multiple ranked candidate paths that differ in efficiency, safety margin, rule conservatism, or recognition-adjusted certainty. In still further embodiments, the path planning subsystem 600 may generate a fallback path, a reduced-speed path, or a minimum-risk maneuver when recognition-related confidence falls below a threshold. The disclosed subject matter therefore encompasses both normal-operation planning and degraded-mode planning.

Referring now to FIG. 7, an example recognition-driven decision engine 700 is illustrated. The decision engine 700 may be configured to prioritize, schedule, allocate, and execute one or more tasks, actions, control decisions, or compute resources according to recognition-derived urgency or risk values. In the illustrated embodiment, the decision engine 700 may include a pending decision queue 702, a risk estimator 704, a normalized risk generator 706, a recognition priority generator 708, a resource allocator 710, a scheduler 712, an execution controller 714, an emergency override path 716, a deferred task queue 718, a compute budget monitor 720, an actuator command interface 722, and a logging and audit module 724. Although FIG. 7 illustrates one example functional arrangement, it will be understood that one or more of these elements may be combined, subdivided, reordered, distributed, or otherwise implemented differently in other embodiments.

The pending decision queue 702 may be configured to receive, store, organize, and maintain one or more candidate decisions, tasks, actions, control updates, or computational jobs awaiting execution or further evaluation. In various embodiments, the pending decision queue 702 may include path-following actions, obstacle-response actions, lane-change actions, speed-adjustment actions, braking actions, steering corrections, communication actions, map-update actions, perception-refresh actions, compute tasks, safety checks, actuator updates, or other operations relevant to autonomous or semi-autonomous platform control. In some implementations, each queued item may be associated with metadata such as a creation time, a deadline, a class label, a source subsystem, a confidence value, a safety relevance value, an expected execution cost, or a mission relevance value. The pending decision queue 702 may therefore serve as an intake and holding structure through which candidate actions can be ranked and managed before execution.

The risk estimator 704 may be configured to determine one or more risk-related metrics associated with one or more queued decisions or tasks. In some embodiments, the risk estimator 704 may evaluate inverse time-to-collision, obstacle proximity, relative velocity, predicted conflict, path inconsistency, object confidence, braking urgency, steering urgency, rule-criticality, mission priority, actuator state, environmental hazard, communication urgency, or combinations thereof. In one example embodiment, a risk-related metric may be represented as:

Risk_j=TTC_inv*ObjectConf*RelVelocity_norm

where Risk_j is a risk-related value associated with a pending decision or task j, TTC_inv is an inverse time-to-collision value or other urgency-related quantity, ObjectConf is an object-confidence-related quantity, and RelVelocity_norm is a normalized relative-velocity quantity. In other embodiments, the risk estimator 704 may compute risk using weighted sums, products, max operations, probabilistic hazard estimates, learned hazard estimators, rule-based hazard evaluation, or other formulations appropriate to a given deployment.

The normalized risk generator 706 may be configured to transform one or more risk-related values produced by the risk estimator 704 into one or more normalized quantities suitable for input to a recognition-based priority mapping. In some embodiments, the normalized risk generator 706 may apply scaling, clipping, range normalization, ratio normalization, reference-based normalization, logarithmic normalization, or probabilistic normalization. In some implementations, the normalized risk generator 706 may use a static normalization value. In other implementations, the normalized risk generator 706 may use mode-specific or platform-specific normalization values, such as values selected according to road speed, indoor robot speed, aerial mission type, or weather mode. The normalized risk generator 706 may further ensure that risk-related inputs supplied to downstream modules remain within a stable numeric range.

The recognition priority generator 708 may be configured to convert the normalized risk-related value into a bounded recognition-based priority. In some embodiments, the recognition priority generator 708 may apply the recognition coverage function or another bounded monotonic mapping to the normalized risk value to generate a priority value that increases as risk increases while remaining bounded. In one example embodiment, a recognition-based priority may be represented as:

Priority_j=F_cov(Risk_j; X_dec)

where Priority_j is a priority value associated with decision or task j, Risk_j is a normalized or otherwise suitable risk-related metric, and X_dec is a positive constant or parameter selected for the decision-prioritization context. In some preferred embodiments, X_dec may correspond to a preferred constant such as phi/pi. In other embodiments, X_dec may be selected based on platform type, decision type, safety mode, certification constraints, or operating conditions. The resulting bounded priority may be used to rank, allocate, or trigger execution in a stable and interpretable manner.

In some embodiments, the decision engine applies one or more thresholds to recognition-derived priority values to trigger discrete control actions. For example, when Priority_j exceeds a high threshold T_high (e.g., 0.6 to 0.9), the decision engine preempts non-critical tasks and triggers an emergency override, minimum-risk maneuver, or safety-mode action; when Priority_j is below a low threshold T_low (e.g., 0.1 to 0.4), the task may be deferred, rate-limited, or executed at a reduced resource budget. In certain embodiments, hysteresis is applied such that a task promoted above T_high remains promoted until Priority_j drops below (T_high-H), where H is a hysteresis

margin (e.g., 0.05 to 0.2), thereby reducing oscillatory scheduling behavior.

The resource allocator 710 may be configured to assign one or more resources to one or more queued tasks or decisions according to the recognition-derived priority values generated by the recognition priority generator 708. In some embodiments, the resource allocator 710 may allocate CPU time, GPU time, FPGA slots, memory bandwidth, communication bandwidth, sensor-refresh budget, control-loop update budget, actuator-update budget, power budget, or data-transfer bandwidth. In some implementations, the resource allocator 710 may assign greater resources to decisions associated with higher recognition-derived priority values while delaying, compressing, or reducing resources allocated to lower-priority items. In this way, the decision engine 700 may direct limited computational and physical resources toward the most urgent or safety-relevant tasks.

The scheduler 712 may be configured to sequence, rank, dispatch, or otherwise manage execution order of one or more pending tasks or decisions. In some embodiments, the scheduler 712 may sort the pending decision queue 702 according to recognition-derived priority values, hard deadlines, task classes, safety rules, dependency relationships, or combinations thereof. The scheduler 712 may implement fixed-priority scheduling, dynamic-priority scheduling, earliest-deadline-first scheduling, weighted scheduling, hybrid scheduling, rule-constrained scheduling, or other execution-management approaches. In some implementations, the scheduler 712 may use recognition-derived priority as a principal scheduling signal while still respecting minimum service guarantees, starvation prevention rules, or certification constraints.

The execution controller 714 may be configured to initiate, supervise, and track execution of one or more selected tasks, actions, or control updates. In some embodiments, the execution controller 714 may trigger actuator commands, invoke perception refreshes, initiate planning updates, launch inference kernels, request communication transmissions, update map states, or otherwise cause selected tasks to be performed. The execution controller 714 may further monitor whether execution completed successfully, whether execution exceeded latency limits, whether execution produced a conflict, or whether follow-up action is required. In some implementations, the execution controller 714 may feed completion status, error status, or updated urgency information back into the pending decision queue 702 or the scheduler 712.

The emergency override path 716 may be configured to support immediate or high-priority intervention when one or more conditions indicate that normal scheduling behavior should be bypassed or superseded. In some embodiments, the emergency override path 716 may be triggered by imminent collision risk, severe system fault, actuator fault, safety-policy threshold exceedance, operator command, remote supervisory command, watchdog trigger, or degraded-confidence conditions. Upon activation, the emergency override path 716 may preempt normal queue order, invoke an emergency stop, initiate a minimum-risk maneuver, reduce speed, hold a current state, or otherwise force a safety-oriented response. In some embodiments, the emergency override path 716 may cooperate with external safety hardware or a safety-certified override module.

The deferred task queue 718 may be configured to receive and manage tasks or decisions that are not immediately executed. In some embodiments, the deferred task queue 718 may store lower-priority items, delayed maintenance tasks, lower-urgency map updates, secondary communication tasks, delayed inference tasks, logging tasks, or tasks awaiting improved system state or additional data. In some implementations, the deferred task queue 718 may preserve ordering information, aging information, and retry conditions so that deferred items can later be reconsidered without being permanently discarded. The deferred task queue 718 may therefore help the decision engine 700 distinguish between urgent actions requiring immediate execution and less urgent items suitable for later processing.

The compute budget monitor 720 may be configured to track one or more resource-availability or execution-budget quantities relevant to operation of the decision engine 700. In some embodiments, the compute budget monitor 720 may monitor available processor cycles, GPU utilization, memory bandwidth, communication throughput, thermal limits, power limits, task backlog, latency margins, or control-loop timing margins. The compute budget monitor 720 may provide such information to the resource allocator 710, the scheduler 712, or the execution controller 714 so that resource assignment and execution timing can reflect actual operating constraints. In some implementations, the compute budget monitor 720 may also support graceful degradation, such as reducing update rates for lower-priority tasks when computational capacity becomes constrained.

The actuator command interface 722 may be configured to provide one or more final or intermediate control commands to one or more downstream actuators or control layers. In some embodiments, the actuator command interface 722 may output steering commands, braking commands, propulsion commands, heading commands, thrust commands, robotic motion commands, waypoint directives, or other action-level outputs. In some implementations, the actuator command interface 722 may also supply associated priority information, confidence information, or safety state information so that downstream control layers can interpret the command in context. Thus, the decision engine 700 may serve not only as an internal computational scheduler, but also as a pathway through which recognition-prioritized decisions become actual control actions.

The logging and audit module 724 may be configured to store, transmit, or otherwise provide records associated with decision prioritization and execution. In some embodiments, the logging and audit module 724 may store the contents of queued items, risk values, normalized risk values, recognition-derived priorities, scheduling decisions, resource allocations, execution timestamps, override events, failure events, deferred-task status, and actuator outputs. In some implementations, such records may be useful for diagnostics, safety review, fleet analysis, regulatory review, debugging, certification support, incident reconstruction, model tuning, or post-event analysis. The logging and audit module 724 may further support explainability by preserving information showing why one task was prioritized over another.

In operation, the decision engine 700 may receive one or more candidate tasks or control actions into the pending decision queue 702, may compute one or more risk-related values using the risk estimator 704, may normalize such values using the normalized risk generator 706, and may generate one or more bounded recognition-based priority values using the recognition priority generator 708. Based on such priority values and on current resource conditions, the resource allocator 710 and the scheduler 712 may determine which tasks are executed immediately, which tasks are deferred, and how available computation and communication resources are assigned. The execution controller 714 may then cause one or more selected tasks to be performed, with emergency situations handled through the emergency override path 716, lower-priority items retained in the deferred task queue 718, resource conditions tracked through the compute budget monitor 720, and outputs supplied through the actuator command interface 722 and recorded by the logging and audit module 724.

In some embodiments, the decision engine 700 may prioritize not only physical control actions but also information-processing actions. For example, a rapidly approaching obstacle may cause the decision engine 700 to allocate more GPU time to a perception refresh, more CPU time to a planning update, more communication bandwidth to a safety-critical V2X transmission, and more actuator-update bandwidth to braking control. In another embodiment, a lower-risk environment may permit more resources to be directed toward background mapping, logging, or route optimization. Accordingly, the decision engine 700 may operate across both cyber and physical dimensions of the autonomous system.

In some embodiments, the risk estimator 704 may combine multiple factors in a learned or semi-learned manner. In other embodiments, the risk estimator 704 may rely on transparent, rule-based, or physically interpretable formulations. In certain implementations, different decision classes may use different risk constructions. For example, braking decisions may prioritize inverse time-to-collision and obstacle confidence, while communication decisions may prioritize mission criticality and situational hazard, and path-replanning decisions may prioritize forecast conflict and localization uncertainty. The disclosed subject matter is intended to encompass each such arrangement so long as one or more recognition-based priority values are generated from one or more risk-related quantities.

In further embodiments, the decision engine 700 may incorporate queue aging, anti-starvation logic, hysteresis, or stability constraints. For example, the scheduler 712 may ensure that certain lower-priority tasks are eventually serviced after sufficient delay, may prevent oscillation between competing priorities, or may preserve continuity of control once a critical maneuver has begun. In another embodiment, the emergency override path 716 may be configured to trigger only after one or more conditions are sustained or cross a threshold with sufficient confidence. Thus, the decision engine 700 may provide both responsiveness and stability in practical deployments.

Referring now to FIG. 8, an example end-to-end recognition-based navigation control loop 800 is illustrated. The end-to-end recognition-based navigation control loop 800 may be configured to integrate recognition-adjusted sensing, perception, planning, and decision operations into a closed-loop control process that generates commands for an autonomous or semi-autonomous platform. In the illustrated embodiment, the end-to-end recognition-based navigation control loop 800 may include an environment input 802, a sensor acquisition stage 804, a recognition-based fusion stage 806, an object detection stage 808, a path planning stage 810, a decision prioritization stage 812, a command generation stage 814, a steering command 816, a braking command 818, a propulsion command 820, a feedback state estimator 822, a closed-loop update path 824, and a safety stop or override path 826. Although FIG. 8 illustrates one example flow-oriented arrangement, it will be understood that one or more of the illustrated stages may be combined, subdivided, reordered, repeated, distributed, or otherwise implemented differently in other embodiments.

The environment input 802 may represent the physical, sensed, inferred, and operational environment in which the autonomous or semi-autonomous platform is operating. In various embodiments, the environment input 802 may include road geometry, lane markings, intersections, traffic-control devices, pedestrians, vehicles, animals, infrastructure, weather, lighting, terrain, obstacles, navigable corridors, mission targets, operator inputs, or other external conditions relevant to autonomous navigation. In some embodiments, the environment input 802 may further include dynamic conditions such as moving vehicles, changing traffic patterns, shifting obstacles, reduced visibility, precipitation, dust, clutter, changing surface conditions, or changing communication availability. The environment input 802 may therefore represent not merely a static scene, but a continuously changing operating context that influences sensing, planning, and control.

The sensor acquisition stage 804 may be configured to obtain sensor data and state data associated with the platform and the environment input 802. In some embodiments, the sensor acquisition stage 804 may include acquisition of camera data, radar data, LiDAR data, ultrasonic data, inertial data, positioning data, odometry data, map data, communication data, or combinations thereof. In some implementations, the sensor acquisition stage 804 may further include timestamping, synchronization, buffering, initial preprocessing, calibration correction, coordinate transformation, packet parsing, or other acquisition-related operations. The sensor acquisition stage 804 may provide its outputs to the recognition-based fusion stage 806, to supporting localization or mapping functions, or to other modules of the autonomous navigation system.

The recognition-based fusion stage 806 may be configured to receive multi-sensor or multi-source inputs and generate a fused perceptual representation using recognition-adjusted weighting as described elsewhere herein. In some embodiments, the recognition-based fusion stage 806 may evaluate one or more reliability-related metrics associated with different sensing modalities, generate one or more bounded recognition factors from such metrics, and use such recognition factors to modify the contribution of one or more sensor inputs to a fused output. The recognition-based fusion stage 806 may therefore produce a fused point cloud, fused object representation, fused semantic map, fused free-space map, fused occupancy representation, or another fused perceptual output that reflects changing sensor quality and changing environmental conditions.

The object detection stage 808 may be configured to receive one or more outputs from the recognition-based fusion stage 806, from one or more direct sensor pathways, or from one or more intermediate perception pipelines and to generate one or more detected-object or scene-understanding outputs. In some embodiments, the object detection stage 808 may apply recognition-based scaling to one or more activations, feature values, logits, objectness values, confidence values, or other inference-related values so that weak, noisy, unstable, or low-information responses are relatively suppressed while stronger or more informative responses are preserved or emphasized. The object detection stage 808 may thereby generate object detections, semantic labels, obstacle descriptions, track associations, segmentation outputs, free-space outputs, lane estimates, or other perception products for downstream use.

The path planning stage 810 may be configured to generate one or more candidate paths, trajectories, or navigational actions based on information supplied by the object detection stage 808, map sources, localization sources, or other modules. In some embodiments, the path planning stage 810 may determine one or more traversability-related, certainty-related, clearance-related, or environmental-confidence-related metrics and may use one or more recognition-derived values to modify node costs, edge costs, trajectory costs, or other planning values. The path planning stage 810 may thereby favor routes, trajectories, or actions associated with greater certainty, stronger evidence of clearance, better traversability, or lower recognition-adjusted risk, while deprioritizing or avoiding routes associated with uncertainty, conflict, or poor environmental support.

The decision prioritization stage 812 may be configured to determine execution priority, scheduling priority, task priority, resource-allocation priority, or control priority based on one or more risk-related quantities. In some embodiments, the decision prioritization stage 812 may compute a risk-related metric from one or more values such as inverse time-to-collision, obstacle confidence, relative velocity, predicted hazard, rule criticality, mission urgency, or system state, may transform such metric into a bounded recognition-based priority value, and may use that priority value to determine how tasks, actions, or resources are allocated. The decision prioritization stage 812 may therefore ensure that high-urgency or safety-relevant actions are advanced relative to lower-priority operations.

The command generation stage 814 may be configured to convert one or more selected paths, actions, priorities, or control decisions into platform-specific control commands. In some embodiments, the command generation stage 814 may translate a selected path or maneuver into steering commands, braking commands, propulsion commands, waypoint commands, thrust commands, or other low-level or intermediate control outputs. In some implementations, the command generation stage 814 may also apply smoothing, constraint enforcement, saturation limits, rate limits, or safety bounds before commands are issued downstream. The command generation stage 814 may therefore serve as a bridge between recognition-informed autonomy decisions and physical platform actuation.

The steering command 816 may correspond to one or more commands for directional control of the platform. In an on-road vehicle embodiment, the steering command 816 may specify a steering angle, steering rate, yaw target, curvature target, or lateral control quantity. In other embodiments, the steering command 816 may correspond to a heading-control command, rudder command, rotor differential command, thrust-vectoring command, or equivalent directional-control instruction appropriate to the platform. The braking command 818 may correspond to one or more deceleration, stop, holding, or braking-control outputs, including brake force, brake pressure, negative torque request, or other deceleration-related commands. The propulsion command 820 may correspond to one or more acceleration, speed, thrust, torque, motor drive, engine control, or propulsive-force commands.

The feedback state estimator 822 may be configured to determine a resulting or updated state of the platform after command execution or during ongoing motion. In some embodiments, the feedback state estimator 822 may estimate current pose, heading, velocity, acceleration, yaw rate, control tracking error, slip state, actuator state, obstacle relationship, lane position, or other state values relevant to closed-loop navigation. The feedback state estimator 822 may be based on inertial sensing, positioning sensing, wheel odometry, visual odometry, LiDAR odometry, radar odometry, actuator feedback, or fused state estimation. The resulting updated state may be used to evaluate whether the issued commands are having the intended effect and whether replanning, reprioritization, or corrective control is required.

The closed-loop update path 824 may represent the feedback mechanism through which information generated after command issuance is returned to earlier stages of the navigation architecture. In some embodiments, the closed-loop update path 824 may carry updated state information, newly observed sensor data, revised environment information, updated recognition-related metrics, new obstacle information, updated task urgency, revised map information, or other data that causes one or more of the earlier stages to repeat or adjust their operations. The closed-loop update path 824 may therefore support repeated sensing, repeated fusion, repeated perception, repeated planning, and repeated decision making as the platform continues moving through the environment.

The safety stop or override path 826 may be configured to interrupt, constrain, replace, or supersede one or more normal command pathways when a safety condition or override condition is present. In some embodiments, the safety stop or override path 826 may be triggered by imminent collision risk, actuator anomaly, sensor-fault severity, operator intervention, remote supervisory command, degraded-confidence conditions, regulatory rule conflict, or watchdog-detected failure. Upon activation, the safety stop or override path 826 may cause a minimum-risk maneuver, controlled stop, reduced-speed mode, hold-state mode, safe-route transition, or disengagement of one or more autonomous functions. The safety stop or override path 826 may therefore provide a direct safety-oriented branch within the overall control loop.

In operation, the end-to-end recognition-based navigation control loop 800 may begin with the environment input 802 and the sensor acquisition stage 804, through which the system obtains updated information regarding the platform and its surroundings. The recognition-based fusion stage 806 may then generate a fused representation in which multi-source inputs are weighted according to recognition-derived reliability or confidence information. The object detection stage 808 may extract objects, scene features, or other perception results from the fused data or related inputs using recognition-adjusted inference logic. The path planning stage 810 may then identify candidate paths or trajectories using recognition-adjusted planning costs, and the decision prioritization stage 812 may determine which actions, tasks, or outputs should be executed according to recognition-derived urgency or risk. The command generation stage 814 may convert such decisions into steering command 816, braking command 818, and propulsion command 820 outputs, after which the feedback state estimator 822 and the closed-loop update path 824 may support repeated execution of the overall cycle.

In some embodiments, the stages of the end-to-end recognition-based navigation control loop 800 may operate at different update rates. For example, low-level control outputs may be updated at a higher rate than path planning outputs, and path planning outputs may be updated at a higher or lower rate than certain background perception or mapping functions. In some implementations, some stages may be event-driven while others are periodic. For example, a sudden obstacle detection may trigger immediate path replanning or immediate decision reprioritization, while ordinary route updates may occur on a slower schedule. Accordingly, the disclosed control loop is not limited to a single fixed-timing architecture.

In some embodiments, the closed-loop architecture may permit recognition-related values to evolve over time as conditions change. A sensor that is initially degraded may later regain reliability, causing the recognition-based fusion stage 806 to increase its influence. A detected object that is initially weak or uncertain may become more strongly recognized over subsequent frames, causing the object detection stage 808 to increase its confidence. A route that is initially disfavored due to uncertainty may become more favorable after additional observations, causing the path planning stage 810 to reevaluate costs. A low-priority task may become higher priority if a risk metric increases, causing the decision prioritization stage 812 to reschedule execution. Thus, the end-to-end recognition-based navigation control loop 800 supports temporal adaptation in response to changing data quality and changing operational conditions.

In further embodiments, the illustrated closed-loop process may be implemented on a centralized computing platform, on a distributed computing architecture, across multiple processors or accelerators, or across onboard and remote computing resources. One or more stages may be carried out by dedicated hardware, firmware, software, or combinations thereof. In some implementations, one or more functions may be shared across modules, such as a common recognition coverage engine that provides bounded recognition factors for fusion, inference, planning, and prioritization. In other implementations, different modules may use different normalization values, different constants, different mapping variants, or different update policies. The disclosed subject matter is intended to encompass each such implementation.

In some embodiments, the end-to-end recognition-based navigation control loop 800 may be used in passenger vehicles, commercial trucks, unmanned aerial vehicles, marine vessels, warehouse robots, agricultural machines, delivery robots, planetary rovers, or other autonomous or semi-autonomous platforms. Although the specific form of the steering command 816, braking command 818, and propulsion command 820 may vary by platform, the disclosed closed-loop architecture may still employ recognition-based sensing, perception, planning, and decision logic to influence platform behavior. The invention is therefore not limited to a particular vehicle class or operating domain.

In additional embodiments, one or more supporting modules not explicitly shown in FIG. 8 may interact with the illustrated control loop. For example, localization, mapping, simultaneous localization and mapping, cooperative perception, vehicle-to-everything communication, fleet coordination, cloud connectivity, diagnostics, logging, calibration, model update, and safety-certification support functions may operate alongside or in conjunction with the illustrated stages. Such modules may provide inputs to, receive outputs from, or constrain the operation of the stages shown in FIG. 8. The omission of such supporting modules from FIG. 8 for simplicity does not limit the scope of the disclosed subject matter.

In some embodiments, the disclosed system may further support adaptive updating of normalization values, mapping constants, thresholds, scheduling parameters, or other recognition-related operating values, provided such updates remain within permitted safety and stability constraints. In some implementations, updated values may be derived from offline calibration, simulation, hardware-in-the-loop testing, fleet analysis, supervised review, or controlled online adaptation. In other implementations, fixed validated values may be retained. Thus, the disclosed control loop supports both static and adaptive embodiments.

The present disclosure therefore provides an integrated autonomous navigation architecture in which bounded recognition-derived values are used across multiple layers of the navigation stack, including sensor fusion, neural inference, path planning, and decision prioritization. By using recognition-based weighting and prioritization throughout the closed-loop process, the disclosed subject matter can improve robustness, adaptability, computational efficiency, and operational safety under changing real-world conditions.

In some embodiments, the disclosed recognition-based autonomous navigation architecture may be implemented using a shared recognition coverage framework in which a single recognition mapping formulation is used across multiple subsystems. In such embodiments, a common bounded mapping function may be used to generate recognition-derived values for sensor fusion, object detection, path planning, and decision prioritization, thereby providing a unified mathematical and operational basis for modifying perception, planning, and control behavior across the autonomy stack. In other embodiments, different subsystems may use different recognition mapping formulations, different normalization approaches, different constants, or different parameter values so that each subsystem may be tuned for its own data characteristics, latency requirements, safety constraints, or performance objectives.

In some embodiments, the recognition-based functions described herein may be implemented using software instructions executed by one or more processors. Such processors may include one or more central processing units, graphics processing units, tensor processors, neural processing units, digital signal processors, field-programmable gate arrays, application-specific integrated circuits, microcontrollers, or combinations thereof. In some implementations, sensor fusion functions may be executed on a first processor, neural inference functions may be executed on a second processor or accelerator, path planning functions may be executed on a third processor, and decision prioritization or control functions may be executed on a safety-oriented processor or controller. In other implementations, multiple functions may be consolidated onto a common compute platform. Accordingly, the disclosed subject matter is not limited to a particular hardware partitioning arrangement.

In some embodiments, the disclosed functions may be embodied in a non-transitory computer-readable medium storing instructions that, when executed by one or more processors, cause the one or more processors to perform one or more of the operations described herein. Such operations may include receiving one or more recognition-related inputs, normalizing one or more recognition metrics, generating one or more bounded recognition factors, weighting one or more sensor inputs, scaling one or more neural inference values, modifying one or more path-planning costs, prioritizing one or more decisions or tasks, generating one or more control commands, updating one or more operating parameters, or combinations thereof. The non-transitory computer-readable medium may include one or more semiconductor memories, magnetic memories, optical memories, solid-state drives, flash memories, or other machine-readable storage media.

In some embodiments, one or more recognition-related values may be computed using exact arithmetic, floating-point arithmetic, fixed-point arithmetic, quantized arithmetic, approximate arithmetic, lookup-table evaluation, polynomial approximation, rational approximation, piecewise-linear approximation, or combinations thereof. For example, a high-performance computing platform may compute the recognition coverage function directly using floating-point operations, while a resource-constrained or safety-certified platform may use a lookup table or piecewise approximation that remains within predetermined error bounds. In this manner, the disclosed recognition-based framework may be adapted to a wide variety of hardware capabilities and certification environments.

In some embodiments, one or more normalization values, mapping constants, thresholds, or related parameters may be fixed. In other embodiments, one or more such values may be selected according to platform type, environment type, speed range, weather condition, mission mode, traffic condition, sensor availability condition, or another operating context. In still further embodiments, one or more such values may be updated over time based on calibration processes, validation processes, simulated results, recorded operational data, or controlled online adaptation. In some implementations, adaptive updates may be constrained by one or more safety bounds, validation checks, rollback rules, non-negativity constraints, rate-of-change limits, certification envelopes, or supervisory approval requirements so that adaptation does not compromise safe operation.

In some embodiments, recognition-related values used in sensor fusion may be derived from signal quality metrics, signal-to-noise metrics, sensor health metrics, latency metrics, environmental suitability metrics, cross-modal agreement metrics, track-consistency metrics, uncertainty values, or combinations thereof. In some embodiments, recognition-related values used in neural inference may be derived from activation magnitude, feature consistency, temporal persistence, cross-modal corroboration, confidence calibration, uncertainty inverse, prediction margin, entropy reduction, or combinations thereof. In some embodiments, recognition-related values used in path planning may be derived from traversability confidence, verified clearance, free-space confidence, obstacle certainty, map consistency, localization confidence, surface condition, rule confidence, cooperative-perception confidence, or combinations thereof. In some embodiments, recognition-related values used in decision prioritization may be derived from time-to-collision, relative velocity, object confidence, predicted conflict severity, actuator urgency, communication urgency, mission criticality, or combinations thereof. The disclosed subject matter is therefore intended to encompass a broad range of recognition-related input constructions.

In some embodiments, the disclosed sensor fusion functions may be applied at different representational levels. By way of example, fusion may occur at a raw measurement level, a feature level, an object level, a track level, an occupancy level, a semantic level, or a route-information level. In some embodiments, recognition-based weights may be applied uniformly to an entire sensor stream. In other embodiments, recognition-based weights may be applied locally to individual regions, channels, objects, classes, features, or temporal segments. Similarly, in some embodiments, recognition-based scaling in neural inference may be applied to a single layer or stage, while in other embodiments it may be applied across multiple layers or branches of a network. The invention is therefore not limited to any single insertion point for recognition-based weighting.

In some embodiments, the disclosed path-planning functions may be implemented in a global planner, a local planner, or both. A global planner may use recognition-adjusted values to select a route across a broader map or road network, while a local planner may use recognition-adjusted values to avoid near-field obstacles, navigate local uncertainty, or refine motion commands in real time. In some implementations, a graph-based planner, lattice planner, sampling-based planner, model predictive controller, trajectory optimizer, or reactive planner may incorporate recognition-adjusted values in different ways. For example, a graph-based planner may apply recognition-adjusted node or edge costs, while a model predictive controller may apply recognition-adjusted penalties within an optimization objective. The disclosed subject matter is intended to encompass each such implementation.

In some embodiments, the disclosed decision-prioritization functions may allocate not only motion-related actions but also computational, communication, and sensing resources. For example, a recognition-derived priority may be used to determine whether to refresh a detector at a higher frequency, whether to allocate more compute time to trajectory replanning, whether to prioritize a safety-critical wireless transmission, whether to increase update rate for a braking controller, or whether to defer non-critical map maintenance. Thus, recognition-based prioritization may govern not only what action is selected, but also how computational and physical resources are distributed across the system.

In some embodiments, one or more disclosed functions may operate in conjunction with localization systems, mapping systems, simultaneous localization and mapping systems, cooperative perception systems, vehicle-to-everything communication systems, remote-supervision systems, cloud-computing systems, or fleet-management systems. For example, a cooperative perception input from another vehicle or from infrastructure may be assigned a recognition-related value based on trust, freshness, spatial consistency, or corroboration with onboard sensing. A remote map update may be weighted according to confidence or validation state before affecting a planning decision. A fleet-management system may distribute updated normalization values or mapping parameters to multiple vehicles subject to validation rules. Accordingly, the disclosed recognition-based framework may extend beyond purely onboard processing.

In some embodiments, the disclosed system may support degraded-mode operation and minimum-risk behavior. For example, if one or more sensing modalities become unavailable or unreliable, recognition-based weighting may reduce their influence while preserving continued operation using remaining sensing modalities. If recognition-related certainty falls below a threshold for safe continued autonomy, the system may reduce speed, limit maneuver complexity, transition to a fallback route, request supervisory assistance, enter a controlled stop, or perform another minimum-risk maneuver. In some embodiments, such degraded-mode behavior may be triggered by recognition-derived values themselves, by explicit fault indicators, or by combinations thereof.

In some embodiments, the disclosed architecture may be used in passenger vehicles operating on public roads, trucks operating in freight or logistics environments, unmanned aerial vehicles operating in aerial corridors or obstacle-rich airspace, marine vessels operating in coastal or open-water environments, agricultural machines operating in unstructured terrain, warehouse robots operating in structured indoor facilities, delivery robots operating in pedestrian or mixed-use environments, or rovers operating in remote or extraterrestrial terrain. Different embodiments may employ different sensor sets, different planning representations, different actuation types, different control frequencies, or different safety policies, yet still apply the disclosed recognition-based framework to improve robustness and adaptability.

In some embodiments, one or more values described herein as nodes, edges, paths, activations, priorities, outputs, or commands may instead be represented using equivalent data structures or control structures. For example, a node may correspond to a cell, voxel, waypoint, state sample, lane segment, or trajectory element. An edge may correspond to a transition, motion primitive, temporal segment, or control interval. An activation may correspond to a feature response, channel response, attention value, objectness score, confidence value, or logit. A command may correspond to a steering angle, torque request, speed setpoint, thrust vector, braking force, or other platform-appropriate control output. The use of particular terminology herein is therefore intended to aid explanation rather than limit scope.

In some embodiments, the order of operations described herein may be varied. Certain steps may occur simultaneously, iteratively, repeatedly, asynchronously, or in partially overlapping fashion. Some embodiments may omit certain steps, add intermediary steps, or rearrange the sequence of operations depending on platform requirements, subsystem design, certification constraints, or implementation preference. Thus, method descriptions provided herein should not be interpreted as requiring a single rigid operational order unless expressly stated otherwise.

In some embodiments, the disclosed system may maintain logs, audit records, explanation records, diagnostic outputs, confidence traces, or other reviewable information showing how recognition-derived values influenced sensing, inference, planning, prioritization, or control. Such records may be useful for debugging, validation, certification, fleet analysis, regulatory review, incident reconstruction, model improvement, or supervisory interpretation. In some implementations, the system may preserve both raw underlying metrics and resulting bounded recognition factors so that downstream effects can be traced more clearly.

Although certain embodiments described herein may be motivated by recognition physics concepts or may employ preferred mathematical forms associated therewith, the invention is not limited to any particular scientific theory of operation. The disclosed subject matter may be practiced using the structures, functions, mappings, workflows, and implementations described herein whether or not any underlying theory is adopted, proven, or relied upon. The scope of the invention is therefore defined by the disclosed systems, methods, media, and equivalents rather than by any particular theoretical explanation.

The present disclosure is intended to cover all such modifications, alternatives, implementations, and equivalents falling within the scope of the appended claims.

1. A recognition-based autonomous navigation system, comprising:
a sensor suite configured to generate sensor data associated with an environment of an autonomous or semi-autonomous platform;
a recognition coverage engine configured to receive at least one recognition-related input, normalize at least one recognition metric derived from the at least one recognition-related input, and generate a bounded recognition factor from the at least one normalized recognition metric;
a sensor fusion subsystem configured to receive a plurality of sensor-derived inputs and to generate a fused perceptual output based at least in part on recognition-adjusted weighting of the plurality of sensor-derived inputs using the bounded recognition factor;
an object detection subsystem configured to receive at least one perception-related input and to apply the bounded recognition factor to at least one neural inference value, activation value, feature value, or detection-related quantity to generate a detected object output;
a path planning subsystem configured to generate one or more candidate paths, trajectories, or navigational actions based at least in part on recognition-adjusted cost values determined using the bounded recognition factor; and
a decision engine configured to generate a recognition-based priority from at least one risk-related input and to control execution of at least one task, action, control decision, or resource allocation based at least in part on the recognition-based priority.

2. The system of claim 1, wherein the recognition coverage engine is configured to generate the bounded recognition factor according to:
F_cov(r; X)=r/(r+X),
where r is a nonnegative normalized recognition metric and X is a positive constant.

3. The system of claim 2, wherein X is phi/pi.

4. The system of claim 1, wherein the sensor suite comprises at least two of a camera subsystem, a radar subsystem, a LiDAR subsystem, an ultrasonic subsystem, or an inertial and positioning subsystem.

5. The system of claim 1, wherein the sensor fusion subsystem is configured to determine a composite recognition metric for at least one sensor stream from a plurality of component metrics and to generate a recognition-based weight for the at least one sensor stream from the composite recognition metric.

6. The system of claim 5, wherein the sensor fusion subsystem is configured to generate a fused representation according to:
S_fused=(sum_i(w_i*S_i))/(sum_i(w_i)+epsilon_f),
where S_i represents a sensor-derived quantity associated with sensor stream i, and w_i represents a recognition-based weight associated with sensor stream i.

7. The system of claim 1, wherein the object detection subsystem is configured to determine an activation magnitude from a raw activation value and to generate a scaled activation according to:
A_scaled=A_raw*F_cov(A_mag; X_det),
where A_raw is the raw activation value, A_mag is the activation magnitude, and X_det is a positive constant.

8. The system of claim 1, wherein the object detection subsystem is configured to apply the bounded recognition factor to at least one of a pre-activation value, an intermediate feature value, a channel value, an attention value, an objectness value, a class-confidence value, a regression-related value, or a post-processing value.

9. The system of claim 1, wherein the path planning subsystem is configured to generate a recognition-adjusted node cost according to:
Cost_rec(n)=Cost_base(n)*(1−F_cov(D_n; X_path)),
where Cost_base(n) is a base cost associated with node n, D_n is a recognition-related metric associated with node n, and X_path is a positive constant.

10. The system of claim 1, wherein the path planning subsystem is configured to generate a recognition-adjusted edge cost according to:
Cost_edge_rec(e)=Cost_edge(e)*(1−F_cov(D_e; X_path)),
where Cost_edge(e) is a base edge cost associated with edge e, D_e is a recognition-related metric associated with edge e, and X_path is a positive constant.

11. The system of claim 1, wherein the path planning subsystem is configured to determine a total path cost based on recognition-adjusted cost and at least one transition-related, dynamic-obstacle-related, or rule-related cost.

12. The system of claim 1, wherein the decision engine is configured to determine a risk-related value from at least one of inverse time-to-collision, object confidence, relative velocity, predicted hazard, rule criticality, mission urgency, or actuator state.

13. The system of claim 12, wherein the decision engine is configured to generate the recognition-based priority according to:
Priority_j=F_cov(Risk_j; X_dec),
where Priority_j is a priority associated with a task or decision j, Risk_j is a normalized risk-related value associated with the task or decision j, and X_dec is a positive constant.

14. The system of claim 1, wherein the decision engine is configured to allocate at least one of processor time, accelerator time, memory bandwidth, communication bandwidth, sensor-refresh budget, control-loop update budget, or actuator-update budget based at least in part on the recognition-based priority.

15. The system of claim 1, further comprising a control interface configured to generate at least one steering command, braking command, or propulsion command based at least in part on outputs of the path planning subsystem and the decision engine.

16. The system of claim 1, further comprising a safety override interface configured to initiate a controlled stop, a minimum-risk maneuver, a reduced-speed mode, or a disengagement of autonomous operation responsive to a safety condition.

17. The system of claim 1, wherein the recognition coverage engine is configured to update the bounded recognition factor at a cadence selected from 10 Hz to 200 Hz or once per received sensor frame, to compute the at least one recognition metric using a sliding window having a duration from 50 ms to 2 s, and to constrain a per-update change in the bounded recognition factor to no more than 0.02 to 0.2 in absolute value.

18. The system of claim 13, wherein the decision engine is configured to trigger a safety action responsive to the recognition-based priority exceeding a high threshold T_high between 0.6 and 0.9, to defer or rate-limit execution responsive to the recognition-based priority being below a low threshold T_low between 0.1 and 0.4, and to apply hysteresis such that a task promoted above T_high remains promoted until the recognition-based priority drops below (T_high-H), where H is between 0.05 and 0.2.

19. A recognition-based autonomous navigation method, comprising:
receiving sensor data associated with an environment of an autonomous or semi-autonomous platform;
deriving at least one recognition metric from at least one sensed, computed, inferred, or estimated value;
normalizing the at least one recognition metric to generate at least one normalized recognition metric;
generating a bounded recognition factor from the at least one normalized recognition metric;
generating a fused perceptual output by applying the bounded recognition factor to recognition-adjusted weighting of a plurality of sensor-derived inputs;
generating a detected object output by applying the bounded recognition factor to at least one neural inference value, activation value, feature value, or detection-related quantity;
generating a path or trajectory by applying the bounded recognition factor to at least one path-planning cost; and
determining execution priority for at least one task, action, or control decision by applying the bounded recognition factor to at least one risk-related input.

20. A non-transitory computer-readable medium storing instructions that, when executed by one or more processors, cause the one or more processors to:
receive sensor data associated with an environment of an autonomous or semi-autonomous platform;
derive at least one recognition metric from at least one sensed, computed, inferred, or estimated value;
normalize the at least one recognition metric to generate at least one normalized recognition metric;
generate a bounded recognition factor from the at least one normalized recognition metric;
apply the bounded recognition factor to recognition-adjusted weighting of a plurality of sensor-derived inputs to generate a fused perceptual output;
apply the bounded recognition factor to at least one neural inference value, activation value, feature value, or detection-related quantity to generate a detected object output;
apply the bounded recognition factor to at least one path-planning cost to generate a path-planning output; and
apply the bounded recognition factor to at least one risk-related input to generate a recognition-based priority for at least one task, action, control decision, or resource allocation.
